(19) United States
(12) Patent Application Publication
(10) Pub. No.: US 2015/0077783 A1
(43) Pub. Date: Mar. 19, 2015

(54) IMAGE FORMING APPARATUS, INFORMATION PROCESSING APPARATUS, INFORMATION PROCESSING SYSTEM, INFORMATION PROCESSING METHOD, AND PROGRAM

(71) Applicants: Satoru KAWAKUBO, Chiba (JP); Seijiro Hori, Tokyo (JP)

(72) Inventors: Satoru KAWAKUBO, Chiba (JP); Seijiro Hori, Tokyo (JP)

(21) Appl. No.: 14/553,485

(22) Filed: Nov. 25, 2014

Related U.S. Application Data
(63) Continuation of application No. 12/556,287, filed on Sep. 9, 2009.

(30) Foreign Application Priority Data
Sep. 16, 2008 (JP) 2008-237122
Sep. 16, 2008 (JP) 2008-237123

(51) Int. Cl. G06F 3/12; H04N 1/00

(52) U.S. Cl. CPC G06F 3/1224; G06F 3/1288; G06F 3/1204; G06F 3/1253; H04N 1/00225; H04N 1/00941; H04N 2201/0094; H04N 2201/0046
USPC 358/1.13

(57) ABSTRACT

Disclosed is an image forming apparatus including a unit that receives application information having function identification information and user identification information from an information processing apparatus and records the received application information in an application information management unit; a unit that acquires from the application information management unit a list of the application information related to the user identification information of an operator of the image forming apparatus and causes the acquired list of the application information to be displayed on a display unit; a unit that receives from the information processing apparatus setting information for the function related to the function identification information included in at least the one application information selected from the list; and a unit that executes the function related to the function identification information based on the setting information.

### CROSS-REFERENCE TO RELATED APPLICATIONS

This application is a Continuation of U.S. patent application Ser. No. 12/556,287, filed Sep. 9, 2009, and is based upon and claims the benefit of priority from Japanese Patent Applications No. 2008-237122, filed Sep. 16, 2008; and No. 2008-237123, filed Sep. 16, 2008, the entire content of each of the foregoing applications is incorporated herein by reference.

### BACKGROUND OF THE INVENTION

1. Field of the Invention

The present invention relates to an image forming apparatus, an information processing apparatus, an information processing system, an information processing method, and a program.

2. Description of the Related Art

In recent years and continuing to the present, office equipment such as image forming apparatuses and facsimile machines has been frequently used in offices to improve the efficiency of business. If people working at the offices (users of the office equipment) register information in their own personal computers and configure (customize) desired functions in advance with respect to the office equipment when the office equipment is installed, the efficiency of business can be further improved.

The users can configure such settings through the operations panel of the office equipment. However, operations on the operations panel of each office equipment are cumbersome and complicated unlike settings on personal computers. Furthermore, if the users want to use plural pieces of office equipment, they have to repeatedly perform the same operations for each office equipment.

In order to solve this problem, a technology has been proposed in which setting data configured on personal computers are downloaded by each office equipment (see, for example, Patent Document 1). With this technology, the users can relatively easily configure the settings for the office equipment on the personal computers.

Patent Document 1: JP-A-2004-234617

However, according to the technology described in Patent Document 1, the downloaded setting data are commonly applied to all the users who use the office equipment. Therefore, the users have to follow the common settings and configure the settings again on the operations panel of the office equipment every time they want to implement individual settings.

### SUMMARY OF THE INVENTION

The present invention has been made in light of the above problems and may provide an image forming apparatus, an information processing apparatus, an information processing system, an information processing method, and a program allowing users to appropriately implement functions in accordance with their desired settings.

According to a first aspect of the present invention, there is provided an image forming apparatus including an application information receiving unit that receives application information from an information processing apparatus and records the received application information in an application information management unit, the application information having function identification information for identifying a function that an application of the information processing apparatus connected via a network requests the image forming apparatus to execute and having user identification information for identifying a user associated with the application; a display control unit that acquires from the application information management unit a list of the application information related to the user identification information of an operator of the image forming apparatus and causes the acquired list of the application information to be displayed on a display unit; a setting information receiving unit that receives from the information processing apparatus setting information for the function related to the function identification information included in at least the one application information selected from the list; and a function execution control unit that executes the function related to the function identification information based on the setting information.

According to a second aspect of the present invention, there is provided an information processing apparatus connected to the image forming apparatus described above via the network, the information processing apparatus including an application information sending unit that sends the application information to the image forming apparatus, the application information having the function identification information on the application of the information processing apparatus and having the user identification information; a setting information sending unit that sends the setting information for the function to the image forming apparatus; and a result receiving unit that receives the information on the execution result of the function from the image forming apparatus. The application executes processing by using the information on the execution result.

According to a third aspect of the present invention, there is provided an information processing method executed by an image forming apparatus, including an application information receiving step of receiving application information from an information processing apparatus and recording the received application information in an application information management unit, the application information having function identification information for identifying a function that an application of the information processing apparatus connected via a network requests the image forming apparatus to execute and having user identification information for identifying a user associated with the application; a display control step of acquiring from the application information management unit a list of the application information related to the user identification information of an operator of the image forming apparatus and causing the acquired list of the application information to be displayed on a display unit; a setting information receiving step of receiving from the information processing apparatus setting information for the function related to the function identification information included in at least the one application information selected from the list; and a function execution control step of executing the function related to the function identification information based on the setting information.

According to a fourth aspect of the present invention, there is provided an information processing method executed by an information processing apparatus connected to the image forming apparatus described above via the network, the information processing method including an application information sending step of sending the application information to the image forming apparatus, the application information having the function identification information on the application of the information processing apparatus and having the user identification information; a setting information sending step of sending the setting information for the function to the image forming apparatus; and a result receiving step of receiving the information on an execution result of the function from the image forming apparatus. The application executes processing by using the information on the execution result.

According to a fifth aspect of the present invention, there is provided an information processing apparatus connected to the image forming apparatus described above via the network, the information processing apparatus including an application information sending unit that sends the application information to the image forming apparatus, the application information having the function identification information on the application of the information processing apparatus and having the user identification information; a registration destination display unit that causes identification information of the image forming apparatus to be displayed on the display unit based on an answer indicating that the application information is registered, the answer being returned in response to sending of the application information; and a setting information sending unit that sends the setting information for the function to the image forming apparatus.

According to a sixth aspect of the present invention, there is provided a recording medium having recorded thereon a program for executing an information processing method executed by an image forming apparatus, the information processing method including an application information receiving step of receiving application information from an information processing apparatus and recording the received application information in an application information management unit, the application information having function identification information for identifying a function that an application of the information processing apparatus connected via a network requests the image forming apparatus to execute and having user identification information for identifying a user associated with the application; a display control step of acquiring from the application information management unit a list of the application information related to the user identification information of an operator of the image forming apparatus and causing the acquired list of the application information to be displayed on a display unit; a setting information receiving step of receiving from the information processing apparatus setting information for the function related to the function identification information included in at least the one application information selected from the list; and a function execution control step of executing the function related to the function identification information based on the setting information.

Other objects, features and advantages of the present invention will become more apparent from the following detailed description when read in conjunction with the accompanying drawings.

### BRIEF DESCRIPTION OF THE DRAWINGS

FIG. 1 is a diagram showing a system configuration example according to a first embodiment;

FIG. 2 is a block diagram showing a hardware configuration example of an image forming apparatus according to the embodiments of the present invention;

FIG. 3 is a block diagram showing a hardware configuration example of a client PC according to the embodiments of the present invention;

FIG. 4 is a flowchart for explaining a processing procedure at the registration of client application information;

FIG. 5 is a diagram showing a configuration example of the client application information;

FIG. 6 shows specific examples of the client application information;

FIG. 7 is a diagram showing a configuration example of a client application management table;

FIG. 8 is a sequence diagram for explaining a processing procedure at the execution of a client application;

FIG. 9 shows specific examples of service setting information;

FIG. 10 is a flowchart for explaining a procedure for deleting the client application information from the client application management table;

FIG. 11 is a diagram showing a second system configuration example according to the first embodiment;

FIG. 12 is a diagram showing a software configuration example of the client PC according to a second embodiment;

FIG. 13 is a sequence diagram for explaining processing for registering the client application in a client application manager;

FIG. 14 is a diagram showing a configuration example of the client application information according to the second embodiment;

FIG. 15 is a second sequence diagram for explaining processing for registering the client application in the client application manager;

FIG. 16 is a flowchart for explaining the processing for registering the client application information by the client application manager;

FIG. 17 is a diagram showing a configuration example of the client application management table managed by the client application manager;

FIG. 18 is a sequence diagram for explaining a processing procedure for transmitting the execution result of a function to the client application;

FIG. 19 is a flowchart for explaining the procedure of processing when a result management unit executes in response to a result acquisition command;

FIG. 20 is a sequence diagram for explaining a processing procedure at the completion of the client application;

FIG. 21 is a flowchart for explaining the deregistration processing of the client application executed by the client application registration unit of the client application manager;

FIG. 22 is a flowchart for explaining the deletion processing of the expired client application information executed by the client application registration unit of the client application manager;

FIG. 23 is a diagram showing a system configuration example according to a third embodiment;

FIG. 24 is a flowchart for explaining the processing procedure at the registration of the client application information in the image forming apparatus;

FIG. 25 is a diagram showing a display example of registration destination information in the client PC;

FIG. 26 is a sequence diagram for explaining the processing procedure at the execution of the client application;

FIG. 27 is a diagram showing a display example of the initial state of a client application operations screen;

FIG. 28 is a diagram showing a display example of the client application operations screen when a user is selected;

FIG. 29 is a diagram showing a display example showing a reason why the client application cannot be executed;

FIG. 30 is a diagram showing a display example of the client application operations screen when the client application is selected;

FIG. 31 is a diagram for explaining an example of inputting the service setting information in the client PC; and

FIG. 32 is a diagram showing a display example of a setting screen.

### DETAILED DESCRIPTION OF THE PREFERRED EMBODIMENTS

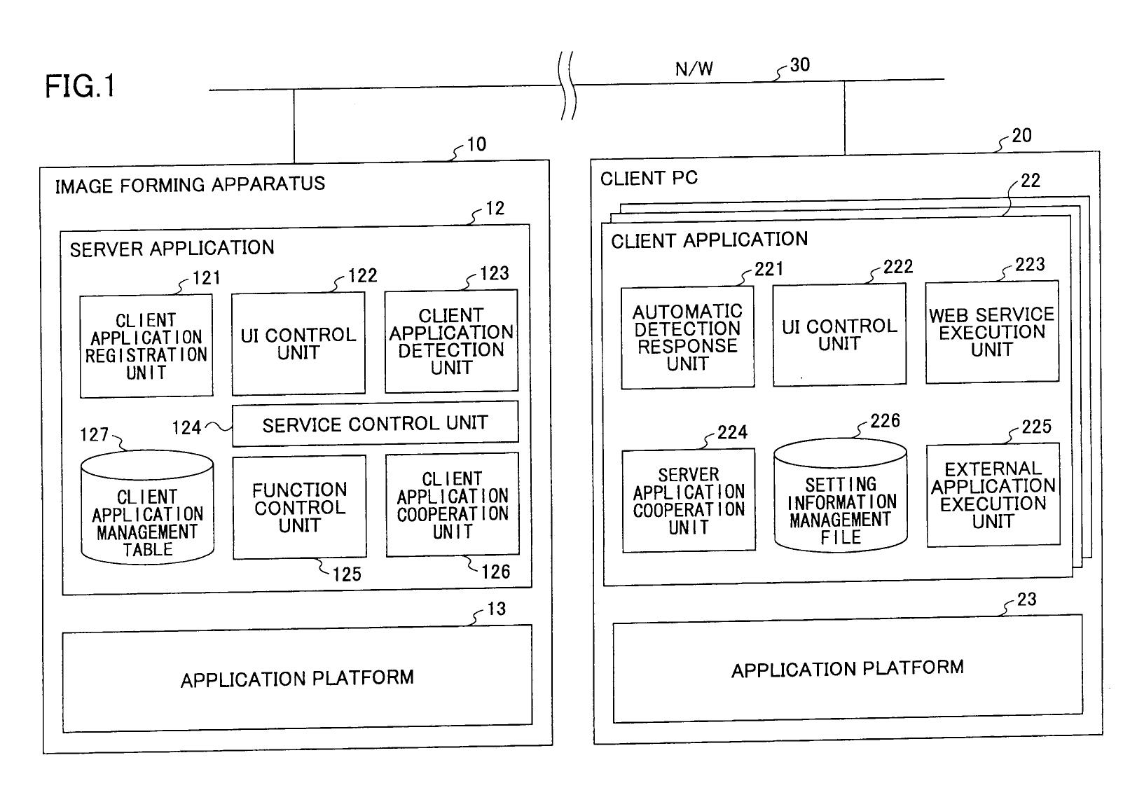

Next, a description is made of embodiments of the present invention with reference to the accompanying drawings. FIG. 1 is a diagram showing a system configuration example according to a first embodiment. In FIG. 1, an image forming apparatus 10 and a client PC 20 are connected to each other via a network 30 (regardless of whether it is a wired or wireless network) such as a LAN (Local Area Network) or the Internet.

The image forming apparatus 10 is a multi-function peripheral that implements the functions of printing, scanning, copying, sending and receiving of a facsimile, and the like in a single housing. Alternatively, an apparatus (such as a printer, a scanner, a copier, or a facsimile machine) that implements any of these functions may be used as the image forming apparatus 10. In FIG. 1, the image forming apparatus 10 has software programs such as a server application 12 and an application platform 13.

The server application 12 is an application program that operates in cooperation with an application program (a client application 22 described below) in the client PC 20. The server application 12 has a client application registration unit 121, a UI control unit 122, a client application detection unit 123, a service control unit 124, a function control unit 125, a client application cooperation unit 126, a client application management table 127, and the like.

The client application detection unit 123 automatically detects the existence of the client application 22 via the network 30. The client application registration unit 121 acquires from the client application 22 information (hereinafter referred to as “client application information”) on the client application 22 detected by the client application detection unit 123 and registers (records) the client application information in (on) the client application management table 127. In addition, the client application registration unit 121 deletes the expired client application information from the client application management table 127.

The UI control unit 122 causes a screen or the like where the client application 22 is used to be displayed on the operations panel of the image forming apparatus 10. For example, the UI control unit 122 causes a list of the client applications 22 (client application list), in which the client application information is registered, to be displayed in the client application management table 127 and allows the user to select the client application 22 to be executed. In other words, the user inputs instructions for executing the client application 22 on the side of the image forming apparatus 10. The service control unit 124 controls the execution of a service that the client application 22 to be executed requests the image forming apparatus 10 to execute. The identification information (service ID) of the service that the client application 22 requests the image forming apparatus 10 to execute is included in the client application information. Note that the “service” described here refers to the execution of functions implemented using hardware resources inherent in the image forming apparatus 10 and the provision of the execution results of the functions. Examples of the service include the execution of a scanning function and the provision of image data as a scanning result, the execution of a printing function and the provision of a printing result, and the like. The client application cooperation unit 126 communicates with the client application 22 in accordance with instructions from the service control unit 124. Through this communication, the client application cooperation unit 126 receives setting information (for example, setting information (execution conditions) for scanning, which is hereinafter referred to as “service setting information”) required for executing the service and sends the execution result (for example, scanned image data) of the service (function). The function control unit 125 exists for each function (the scanning function, the printing function, and the like) of the image forming apparatus 10 to perform processing control in accordance with each function.

The application platform 13 is a software program that provides the execution environment of the server application 12 and includes the driver program and the like of various hardware resources of an OS (Operating System) and the image forming apparatus 10.

The client PC 20 is a general PC (Personal Computer) and provided, for example, one for each user. Each client PC 20 has software programs such as the client application 22 and the application platform 23.

The client application 22 implements an operating logic (such as a workflow) installed in the client application 22 in cooperation with the server application 12 and exists for each operating logic. Each client application 22 has an automatic detection response unit 221, a UI control unit 222, a Web service execution unit 223, a server application cooperation unit 224, an external application execution unit 225, a setting information management file 226, and the like.

The automatic detection response unit 221 responds to a message for detecting the client application 22 issued (sent) from the client application detection unit 123. In addition, the automatic detection response unit 221 returns the client application information in response to a request from the client application registration unit 121. The server application cooperation unit 224 sends the service setting information and receives information on the execution results of the services in response to a request from the client application cooperation unit 126. The service setting information is registered in the setting information management file 226. The Web service execution unit 223 uses the execution result (for example, scanned image data) of the service to implement the function cooperating with a Web service not shown. The external application execution unit 225 uses the execution result of the service to implement the function cooperating with external applications (other application in the client PC) not shown. Note that the Web service execution unit 223 and the external application execution unit 225 may not have the client application 22 that does not require cooperation with the outside.

The application platform 23 is a software program that provides the execution environment of each client application 22 and includes an OS and the like.

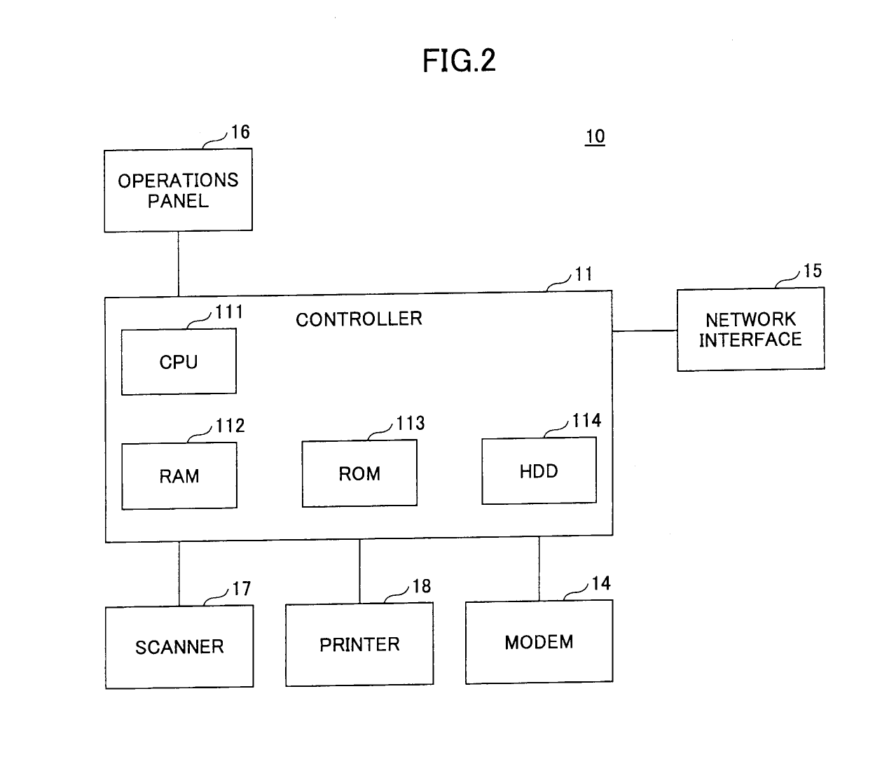

Next, a description is made of the hardware configuration of each unit. FIG. 2 is a block diagram showing a hardware configuration example of the image forming apparatus according to the embodiments of the present invention. In FIG. 2, the image forming apparatus 10 has hardware devices such as a controller 11, a scanner 17, a printer 18, a modem 14, a network interface 15, an operations panel 16, and the like.

The controller 11 is composed of a CPU 111, a RAM 112, a ROM 113, a HDD 114, and the like. On the ROM 113, various programs, data used by the programs, and the like are recorded. The RAM 112 is used as a storage area where the programs are loaded, the work area or the like of the loaded programs, and the like. The CPU 111 processes the programs loaded on the RAM 112 to implement various functions. On the HDD 114, programs, various data (for example, the client application management table 127) used by the program, and the like are recorded.

The scanner 17 is a hardware device for scanning image data from a document. The printer 18 is a hardware device for printing image data on a print sheet. The modem 14 is a hardware device for establishing connection with a telephone line and used for sending and receiving image data through facsimile communication. The network interface 15 is a hardware device for establishing connection with a network (regardless of whether it is a wired or wireless network) such as a LAN (Local Area Network). The operations panel 16 is a hardware device having buttons, a liquid crystal panel, and the like through which an input from the user is received and the user is notified of information.

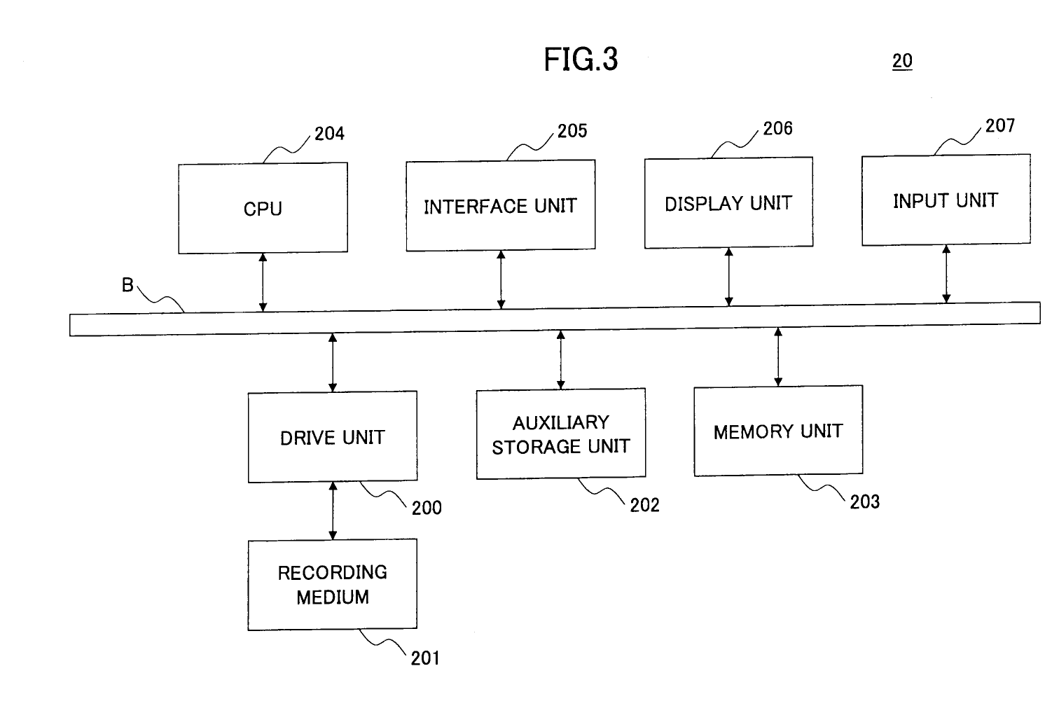

FIG. 3 is a block diagram showing a hardware configuration example of the client PC according to the embodiments of the present invention. The client PC 20 in FIG. 3 has a drive unit 200, an auxiliary storage unit 202, a memory unit 203, a CPU 204, an interface unit 205, a display unit 206, and an input unit 207, all of which are connected to one another via a bus B.

The program that implements processing in the client PC 20 is provided from a recording medium 201 such as a CD-ROM. When the recording medium 201 on which the program is recorded is set in the drive unit 200, the program is installed in the auxiliary storage unit 202 from the recording medium 201 via the drive unit 200. However, the program is not necessarily installed from the recording medium 201, but it may be downloaded from other computers via a network. The auxiliary storage unit 202 stores, in addition to the installed program, necessary files, data (for example, the setting information management file 226), and the like.

When receiving instructions for starting a program, the memory unit 203 reads the program from the auxiliary storage unit 202 and stores the same in it. The CPU 204 implements the function related to the client PC 20 in accordance with the program stored in the memory unit 203. The interface unit 205 is used as an interface for establishing connection with a network. The display unit 206 displays a GUI (Graphical User Interface) according to the program, or the like. The input unit 207 is composed of a keyboard, a mouse, and the like and used for allowing the user to input various operating instructions.

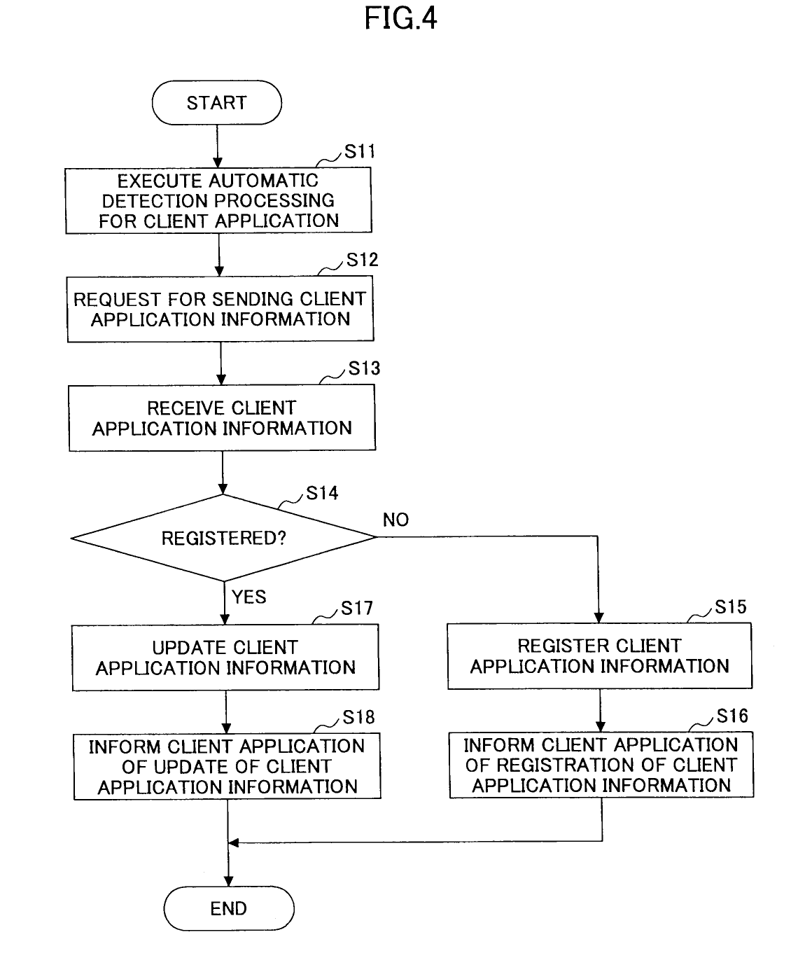

Next, a description is made of the processing procedure of a system according to this embodiment. FIG. 4 is a flowchart for explaining the processing procedure at the registration of the client application information.

In step S11, the client application detection unit 123 of the server application 12 executes processing (automatic detection processing) for detecting the existence of the client application 22 available (activating) on the network 30. The automatic detection processing has, for example, a procedure in which the image forming apparatus 10 automatically detects the client PC 20 connected to the network 30 through a broadcast or the like; a procedure for sending a message (client application detection message) for detecting the client application 22 to the detected client PC 20; and a procedure for receiving a response to the message from the automatic detection response unit 221 of the client application 22. Furthermore, the IP address of the client PC 20 to be detected may be registered in advance in the image forming apparatus 10, or the user may appropriately input the IP address through the operations panel 16. In this case, it is possible to send the client application detection message to the registered IP address without following the procedure for detecting the client PC 20.

Next, the client application registration unit 121 requests the automatic detection response unit 221 of the client application 22 detected by the client application detection unit 123 to send the client application information (S12). Then, the client application registration unit 121 receives the client application information of the client application 22 returned from the automatic detection response unit 221 in response to the request (S13). Note that the client application information is stored in the auxiliary storage unit 202 so as to be associated with each client application 22.

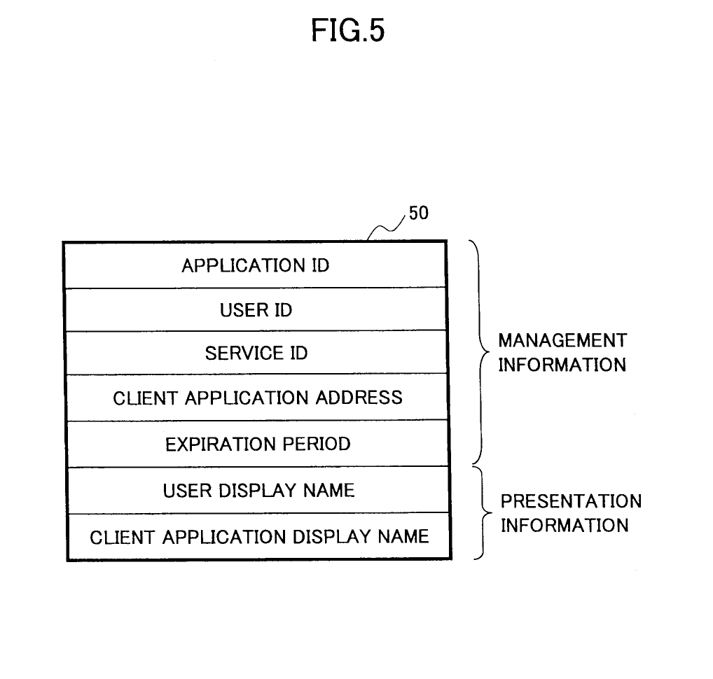

FIG. 5 is a diagram showing a configuration example of the client application information. In FIG. 5, the client application information 50 includes management information and presentation information. The management information is required when the server application 12 executes a logic and includes an application ID, a user ID, a service ID, a client application address, an expiration period, and the like. The presentation information is used as display information and includes a user display name, a client application display name, and the like.

The application ID is identification information for uniquely identifying each client application 22. The user ID is the identification information of the user associated with the client application 22. The service ID is the service ID described above. The client application address is identification information for uniquely identifying each client application 22 on the network 30. The expiration period is the expiration period of the client application information 50 and used as information for making a determination when the client application registration unit 121 deletes the client application information 50 from the client application management table 127. The user display name is a character string for displaying the name of the user corresponding to the user ID. The client application display name is a character string for displaying the name of the client application 22.

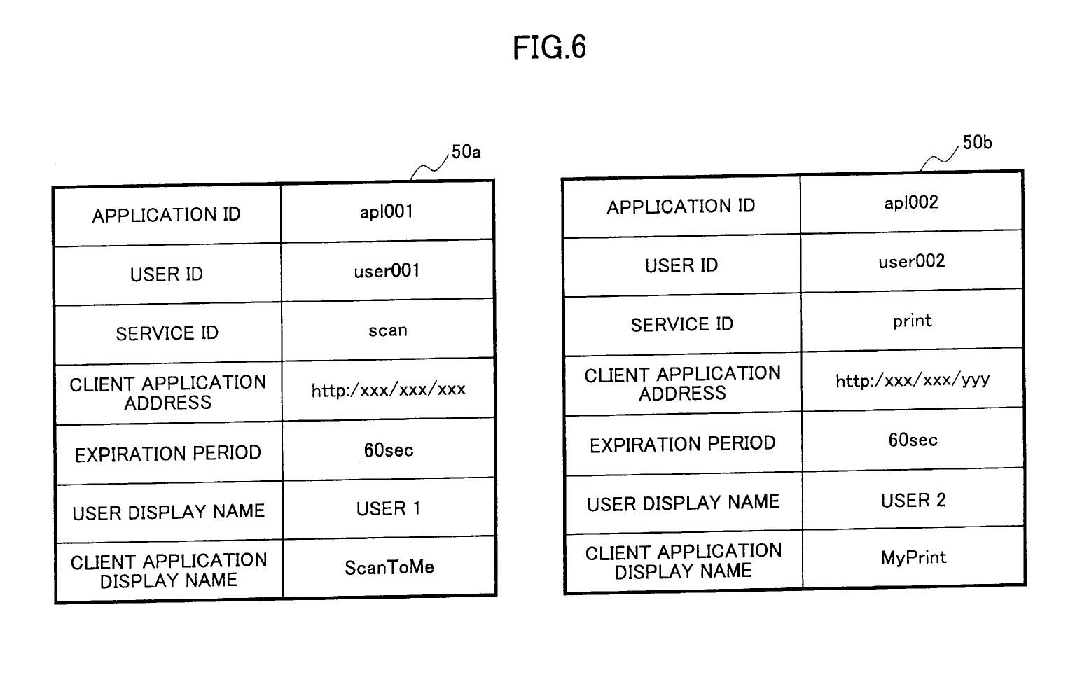

FIG. 6 shows specific examples of the client application information. In FIG. 6, client application information 50a and client application information 50b are shown as the specific examples of the client application information 50.

The client application information 50a is the client application information 50 of the client application 22 (hereinafter referred to as a “ScanToMe application”) called “ScanToMe.” The ScanToMe application is the client application 22 that implements the function of causing the image forming apparatus 10 to perform scanning and storing scanned image data in a predetermined storage area (for example, a predetermined folder) of the auxiliary storage unit 202 of the client PC 20. Accordingly, “scan” of the service ID represents the scanning function of the image forming apparatus 10. Furthermore, the client application display name is indicated as “ScanToMe.” Accordingly, the ScanToMe application is expressed as the character string of “ScanToMe” in the client application list.

On the other hand, the client application information 50b is the client application information 50 of the client application 22 (hereinafter referred to as a “MyPrint application”) called “MyPrint.” The MyPrint application is the client application 22 that implements the function of causing the image forming apparatus 10 to print predetermined document data stored in the auxiliary storage unit 202 of the client PC 20. Accordingly, “print” of the service ID represents the printing function of the image forming apparatus 10. Furthermore, the client application display name is indicated as “MyPrint.” Accordingly, the MyPrint application is expressed as the character string of “MyPrint” in the client application list.

Note that in the client application information 50a and the client application information 50b, a URL allocated to each client application 22 is used as the client application address. However, the client application address is not limited to the URL. The client application address may be information by which each client application 22 can be identified on the network 30. For example, the client application address may be a combination of the IP address of the client PC 20 and information (for example, a port number) by which the client application 22 can be identified in the client PC 20.

Upon receipt of the client application information 50, the client application registration unit 121 determines whether the received client application information 50 has been registered in the client application management table 127 (S14). The determination of the client application information 50 may be made based on the application ID, the user ID, and the client application address. If the client PC 20 in which the client application 22 is installed is different even where the client application 22 has the same function (for example, the ScanToMe application), the client application address is different. Furthermore, if the user is different, the user ID is different. From the reasons above, it is reasonable that each client application 22 should be identified based on the combination of the application ID, the user ID, and the client application address.

If the client application information 50 has not been registered in the client application management table 127 (No in S14), the client application registration unit 121 newly registers the client application information 50 in the client application management table 127 (S15).

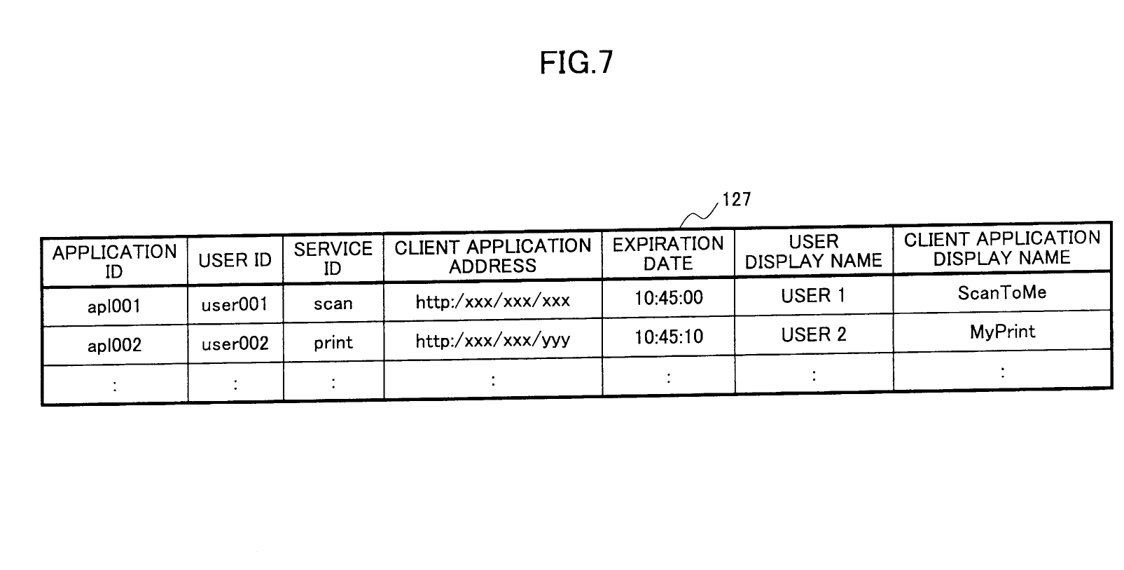

FIG. 7 is a diagram showing a configuration example of the client application management table. As shown in FIG. 7, the values of the items of the client application information are registered in the client application management table 127 as they are. However, the expiration period is replaced by an expiration date. In other words, the client application registration unit 121 registers in the client application management table 127 the time obtained by adding the expiration period to time at registration as the expiration date. Note that in the client application management table 127 shown in FIG. 7, the client application information 50a and the client application information 50b shown in FIG. 6 are registered.

Subsequently, the client application registration unit 121 sends a message indicating that the client application information 50 has been registered to the automatic detection response unit 221 of the client application 22 corresponding to the registered client application information 50 (S16).

On the other hand, if the received client application information 50 has been registered in the client application management table 127 (Yes in S14), the client application registration unit 121 updates information that has been registered with the received client application information 50 (S17). Thus, the expiration date is updated (extended). Then, the client application registration unit 121 sends a message indicating that the client application information 50 has been updated to the automatic detection response unit 221 of the client application 22 corresponding to the client application information 50 (S18).

Note that the client application registration unit 121 may include information indicating the expiration date of the client application information 50 in the message sent in step S16 or step S18. Based on the information, the automatic detection response unit 221 that has received the information may send a request for reregistering the client application information 50 within the expiration date to the client application registration unit 121.

Furthermore, in accordance with step S16 or step S18, the UI control unit 222 of the client application 22 may cause a screen indicating that the client application information 50 has been registered or updated to be displayed on the display unit 206 as a pop-up. In this case, the message in step S16 or step S18 may contain the identification information (information indicating an equipment name or an arrangement position or the like) of the image forming apparatus 10 in which the client application information 50 has been registered. Thus, together with the client application display name of the client application 22 corresponding to the client application information 50, the UI control unit 222 can display on the screen the identification information of the image forming apparatus 10 in which the client application information 50 has been registered. As a result, the user who views the screen can recognize which image forming apparatus 10 provides the client application 22.

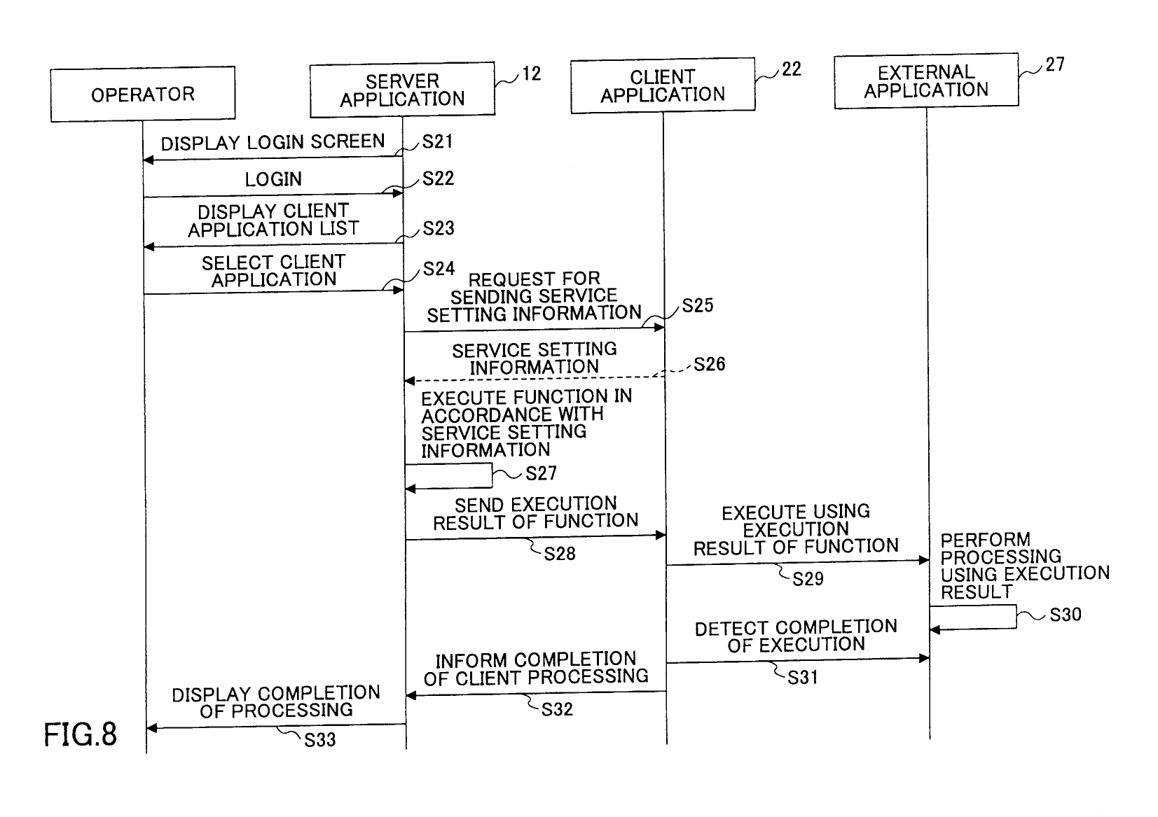

Next, a description is made of a processing procedure when the client application 22 is used (executed). FIG. 8 is a sequence diagram for explaining the processing procedure at the execution of the client application 22.

For example, when the user (operator of the image forming apparatus 10) presses a predetermined key (key corresponding to the server application 12) on the operations panel 16, the UI control unit 122 of the server application 12 causes a login screen corresponding to the server application 12 to be displayed on the operations panel 16 (S21). Then, when the user inputs a user ID and a password via the login screen, the UI control unit 122 causes an authentication unit not shown to authenticate the user (S22). If the authentication is successful, the user is recognized as a login user in the image forming apparatus 10 and allowed to execute the subsequent processing. Note that an operator may be identified based on an IC card. In other words, the operator may be identified based on information that a card reader connected to the image forming apparatus 10 reads from the IC card. Furthermore, if requirements for security are not severe, it is possible to display a list of users on the operations panel 16 so that the user selected from the list is recognized as the operator.

Then, the UI control unit 122 retrieves from the client application management table 127 the client application information having a user ID matching the user ID of the login user and causes a list (client application list) of the client application display names of the retrieved client application information to be displayed on the operations panel 16 (S23). In other words, each user is allowed to use only the client application 22 that includes his/her user ID in the application information.

Next, the operator selects the client application 22 to be executed from the client application list and presses a start key on the operations panel 16 (S24). When the user presses the start key, the UI control unit 122 informs the service control unit 124 of the service ID included in the client application information of the selected client application 22 (hereinafter referred to as a “current client application”). The service control unit 124 performs processing control in accordance with the informed service ID. In other words, the service control unit 124 understands the meaning of the service ID and knows which function should be executed for each service ID. Note that the association of the service ID with the function to be executed may be incorporated in the service control unit 124 as logic or stored in the HDD 114 as a definition file.

Furthermore, the processing in step S21 through step S24 described above can be replaced by the following processing steps. First, before the operator performs the login processing in step S22, a list of the client application display names of the client application information registered in the client application management table 127 is displayed on the operations panel 16 (S231). Next, when a desired client application is selected from the displayed list, a list of the users corresponding to the selected client application is acquired from the client application management table 127 and displayed on the operations panel 16 (S232). Then, when one user is selected from the list of the users displayed on the operations panel 16, the login processing is performed with respect to the selected user (S22). If the authentication of the user is successful in the login processing, the service ID is informed to the service control unit 124 with the press (S24) of the start key on the operations panel 16.

For example, when it is required that service setting information be acquired from the current client application, the service control unit 124 instructs the client application cooperation unit 126 to acquire the service setting information (for example, setting information for the scanning function when the service ID is “scan” and setting information for the printing function when the service ID is “print”) corresponding to the service ID. At this time, the client application address of the current client application is informed to the client application cooperation unit 126. In accordance with the instruction, the client application cooperation unit 126 requests the current client application 22 to send the service setting information based on the client application address (S25).

Upon receipt of the request, the server application cooperation unit 224 of the current client application acquires (reads) the service setting information from the setting information management file 226 corresponding to the current client application and returns the service setting information to the client application cooperation unit 126 (S26).

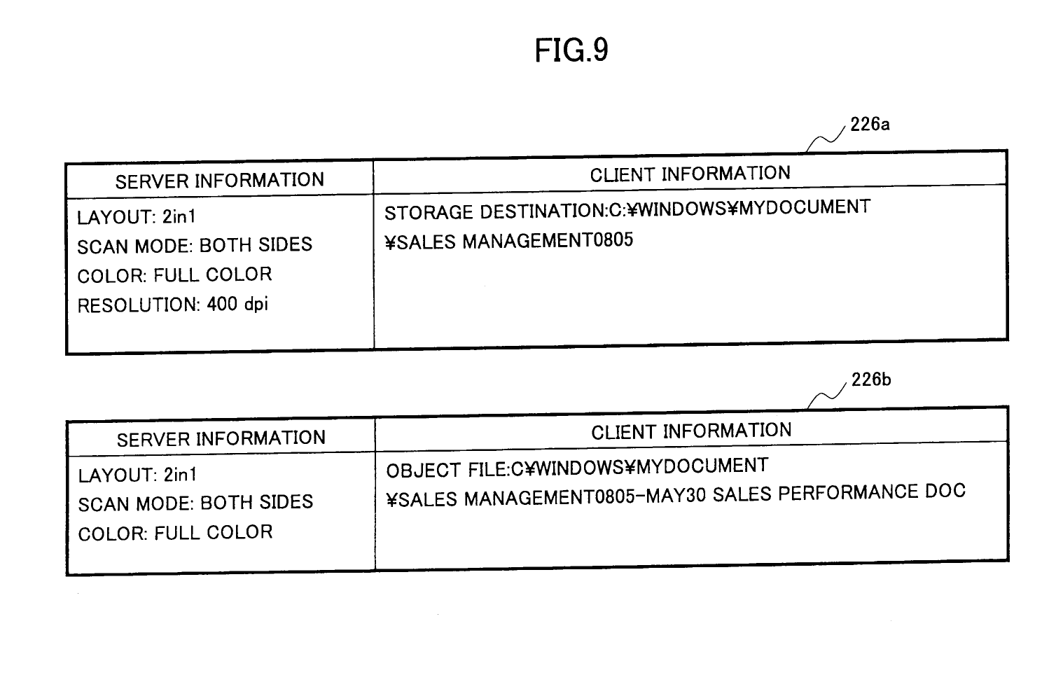

FIG. 9 shows specific examples of the service setting information. In FIG. 9, reference numeral 226a denotes an example of the service setting information stored in the setting information management file 226 of the ScanToMe application. Furthermore, reference numeral 226b denotes an example of the service setting information stored in the setting information management file 226 of the MyPrint application.

Each service setting information is composed of server information and client information. The server information is required when the image forming apparatus 10 (server application 12) executes the service. The client information is required when the client PC 20 (client application 20) causes the image forming apparatus 10 to execute the service.

For example, the server information of the service setting information 226a represents conditions for executing scanning. The client information represents the name of a folder where image data as the execution result of scanning are to be stored. Furthermore, the server information of the service setting information 226b represents conditions for executing printing. The client information represents the name of a file to be printed.

Basically, all the service setting information is not necessarily sent to the server application 12. At least the server information is required to be sent. However, in the case of the MyPrint application, an object file specified in the client information is acquired and sent to the server application 12 together with the server information. Thus, handling of the client information (timing at which the client information is used) could be different depending on the client application 22.

The service setting information received by the client application cooperation unit 126 is reported to the service control unit 124. The service control unit 124 invokes the function control unit 125 corresponding to the service ID and informs the function control unit 125 of the service setting information.

Note that the service setting information may be sent to the client application registration unit 121 together with the client information 50 at the detection of the client application 22 and registered in the client application management table 127. In this case, it is not required that the service setting information be acquired in steps S25 and S26. However, from the viewpoint of the fact that the capacity of the memory of built-in type equipment such as the image forming apparatus 10 is small, it is desired that only the client application information 50 be registered in the client application management table 127.

Subsequently, the invoked function control unit 125 executes the function (scanning function, printing function, or the like) based on the service setting information (S27). For example, the function control unit 125 corresponding to the scanning function causes the scanner 17 to scan a document set on the image forming apparatus 10 by the user and outputs resulting image data to the service control unit 124 as the execution result of the function. Furthermore, the function control unit 125 corresponding to the printing function causes the printer 18 to print an object print file received from the client application 22 together with the service setting information and outputs information indicating the result (for example, success or failure of the printing) to the service control unit 124 as the execution result of the function.

The service control unit 124 instructs the client application cooperation unit 126 to send the execution result of the function to the current client application. In accordance with the instruction, the client application cooperation unit 126 sends the execution result of the function (service) to the server application cooperation unit 224 (S28).

When the execution result of the function is received by the server application cooperation unit 224, the current client application executes processing in accordance with an operating logic installed in the current client application. For example, the current client application stores the image data (scan data) included in the execution result of the function in a storage destination registered in the client information of the service setting information 226a. Furthermore, the current client application causes the printing result included in the execution result of the function to be displayed on the display unit 206. Furthermore, if the current client application cooperates with the external application 27, the external application execution unit 225 of the current client application invokes the external application 27 and informs the external application 27 of the execution result of the function (S29). The invoked external application 27 executes processing inherent in the external application 27 (S30). The processing of the external application 27 is not limited to a predetermined one, but it is varied depending on a solution, a workflow, or the like desired to be implemented. For example, the scan image may be subjected to an OCR (Optical Character Reader), or it may be registered in a predetermined document management DB.

When the external application execution unit 225 detects the execution of the processing of the external application 27 (S31), the server application cooperation unit 224 informs the client application cooperation unit 126 that the processing of the current client application (client processing) has been completed (S32). When the client application cooperation unit 126 receives the information in the completion of the client processing, the UI control unit 122 causes the completion of the processing of the current application to be displayed on the operations panel 16 (S33).

Meanwhile, the client application 22 is not necessarily activated after having being detected by the client application detection unit 123. For example, the client application 22 may be stopped due to user's convenience or the like. The client PC 20 may be turned off. Furthermore, the client application 22 may be activated after the client application detection unit 123 has executed the automatic detection processing. Accordingly, an inconsistency between the client application management table 127 and the client application 22 actually available may occur. As a result, the client application 22 selected from the client application list displayed on the operations panel 16 may not be executed, or the client application 22 actually available may not be included in the client application list.

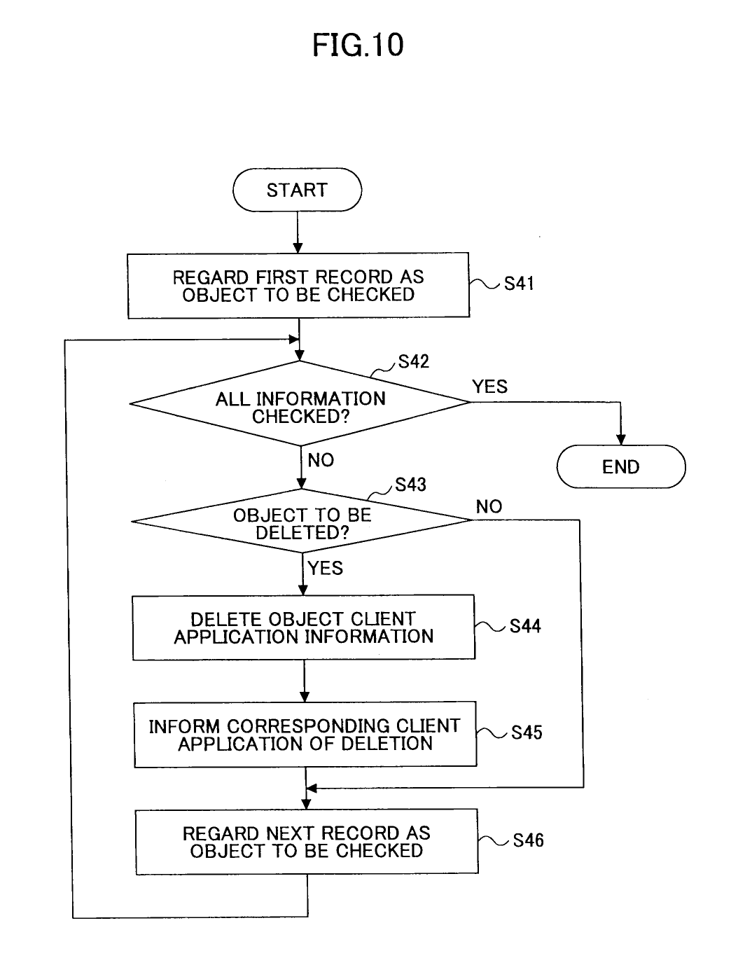

To this end, the client application detection unit 123 may be configured to execute automatic detection processing of the client application 22 on a regular basis (for example, every several seconds, several minutes, or several hours). Thus, the client application information 50 of the newly-activated client application 22 could be appropriately registered in the client application management table 127. In addition, the client application registration unit 121 may execute processing shown in FIG. 10 on a regular basis.

FIG. 10 is a flowchart for explaining a procedure for deleting the client application information from the client application management table.

In step S41, the client application registration unit 121 regards the first record as an object to be checked among those registered in the client application management table 127. Then, the client application registration unit 121 determines whether all the information in the client application management table 127 has been checked (S42).

If all the information has been checked (Yes in S42), the processing in FIG. 10 is completed. If all the information has not been checked (No in S42), the client application registration unit 121 determines whether the client application information 50 related to the record to be checked is to be deleted (S43). Specifically, the client application registration unit 121 determines whether the present time has elapsed the expiration date of the client application information 50.

If it is determined that the client application information 50 is an object to be deleted (the present time has elapsed the expiration date) (Yes in S43), the client application registration unit 121 deletes the client application information 50 from the client application management table 127 (S44). Then, the client application registration unit 121 orders the automatic detection response unit 221 of the client application 22 related to the client application information 50 to delete the client application information 50 (S45). Note that the automatic detection response unit 221 of the client application 22 (i.e., client application 22 that is unregistered from the client application management table 127 although it is in an executable state) that has been ordered to delete the client application information 50 may send a request for reregistering the client application information 50 to the client application registration unit 121 in response to this order.

Next, the client application registration unit 121 regards the next record as an object to be checked (S46) and repeatedly performs the steps following step S42.

In the processing in FIG. 10, the expired client application information 50 can be deleted from the client application management table 127. Accordingly, in combination with the automatic detection processing executed by the client application detection unit 123 on a regular basis, an inconsistency between the client application management table 127 and the client application 22 actually available can be reduced.

Note that when the client application 22 is detected by the client application detection unit 123 after the application information 50 of the client application 22 is deleted due to the expiration date, the client application information 50 of the client application 22 is reregistered in the client application management table 127. After the reregistration, the client application 22 can be executed by the image forming apparatus as described in FIG. 8.

Furthermore, it is so designed that when the client PC 20 informs the image forming apparatus 10 of the completion of the client application 22, the client application information related to the client PC 20 that has been informed of the completion of the client application by the client application management unit may be deleted regardless of the expiration date of each client application information.

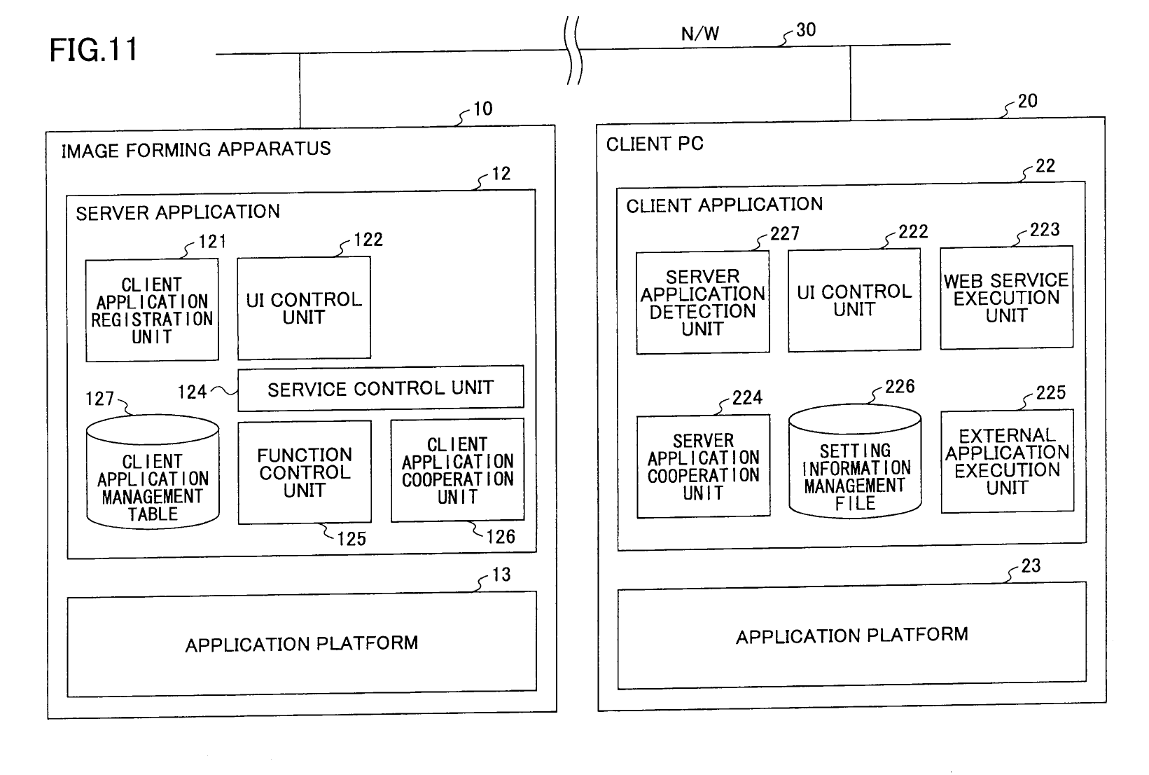

The above description refers to a case in which the server application 12 detects the client application 22. Alternatively, the client application 22 may detect the server application 12 and request for the registration of the client application information 50. A system configuration example of such a mode is shown in FIG. 11.

FIG. 11 is a diagram showing a second system configuration example according to the first embodiment. In FIG. 11, components the same as those of FIG. 1 are denoted by the same reference numerals and their descriptions are omitted. In FIG. 11, the server application 12 does not have the client application detection unit 123. Furthermore, the client application 22 has a server application detection unit 227 instead of the automatic detection response unit 221.

In the case of the configuration shown in FIG. 11, the server application detection unit 227 of each client application 22 sends a message for detecting the server application 12 (server application detection message) to the network 30. Upon receipt of the server application detection message, the client application registration unit 121 of each server application 12 sends a response corresponding to the message. The server application detection unit 227 sends the client application information to the client application registration unit 121 as the source of the response. The following processing steps may be the same as those after step S14 in FIG. 4.

Note that the service ID of the service that the client application 22 wants to use (i.e., service ID included in the service setting information related to the client application 22) may be included in the server application detection message. The client application registration unit 121 that has received the server application detection message including the service ID determines whether the function corresponding to the service ID can be executed in the image forming apparatus 10 (the function control unit 125 corresponding to the service ID exists). The client application registration unit 121 is only required to send a response if it is determined that the function can be executed. Thus, the client application information of the client application 22 is registered in only the image forming apparatus 10 that can execute the service requested by the client application 22. As a result, only the client application 22 that the image forming apparatus 10 can provide is allowed to be displayed on the operations panel 16 as the client application list. Note that determination by the image forming apparatus 10 as to whether the function corresponding to the service ID can be executed may be based on a list of executable service IDs stored in advance in the HDD 114.

Similarly, in the case of the configuration shown in FIG. 1, the client application detection unit 123 may include a list of the service IDs of the services that the image forming apparatus 10 can execute in the client detection message. The automatic detection response unit 221 of each client application 22 that has received the client detection message returns a response if the service ID included in the client detection message is the service ID of the service requested by the automatic detection response unit 221 itself. Thus, only the client application information of the client application 22 capable of being detected by the image forming apparatus 10 is registered in the client application management table 127.

As described above, according to the first embodiment, any client application 22 (workflow) in which the function of the image forming apparatus is incorporated can be executed through the operations panel 16 of the image forming apparatus 10. At this time, as for the function of the image forming apparatus, the setting information (service setting information) is held on the basis of the client application 22 associated with the user. Therefore, more private (user-inherent) workflow can be implemented

Furthermore, operations for executing each client application 22 are uniformalized (selection from the client application list and pressing of the start key) even if a different function or a different workflow is implemented. Therefore, the operator is not required to memorize the operations for each function and each workflow.

Moreover, the image forming apparatus 10 is only required to provide a simple image input/output function, and additional processing is executed by the client PC 20. Therefore, the complexity of the functions of the image forming apparatus 10 can be avoided. Also, complicated functions can be installed in the client PC 20 that is generally less restrictive in all respects.

Furthermore, each client application 22 is automatically detected and registered in the image forming apparatus 10. Accordingly, the user is not required to register each client application 22 in the image forming apparatus 10. Furthermore, the client application 22 on the absent client PC can be excluded from objects to be registered. Therefore, when the client application 22 is selected in the image forming apparatus 10, presentation of unnecessary candidates to be executed can be avoided.

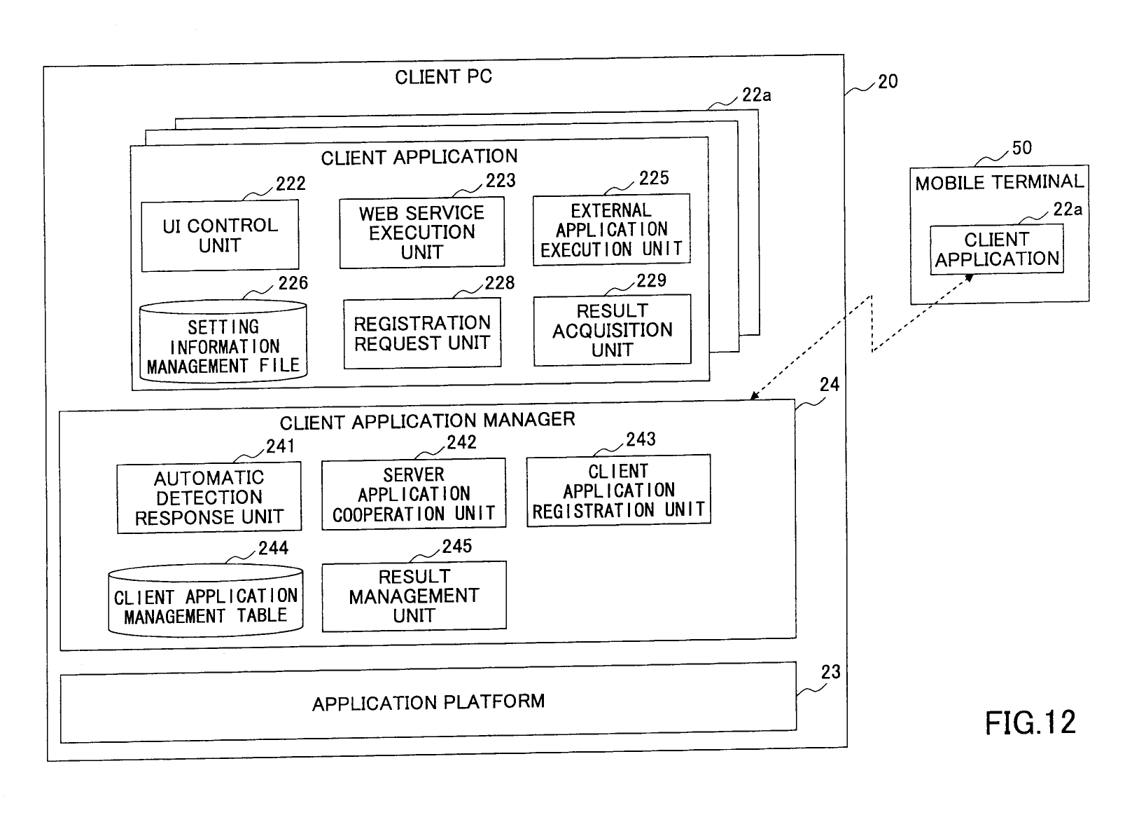

Next, a description is made of a second embodiment as a modification of the configuration of the client application 22. FIG. 12 is a diagram showing a software configuration example of the client PC according to the second embodiment. In FIG. 12, components the same as those of FIG. 1 are denoted by the same reference numerals. Note that a software configuration example of the image forming apparatus 10 may be the same as that of the image forming apparatus 10 shown in FIG. 1.

The second embodiment is greatly different from the first embodiment in that the client PC 20 has a client application manager 24. The client application manager 24 performs processing (communication processing or the like) related to cooperation with the server application 12 with respect to plural client applications 22a in a collective or common manner. In FIG. 12, the client application manager 24 has an automatic detection response unit 241, a server application cooperation unit 242, a client application registration unit 243, a client application management table 244, a result management unit 245, and the like.

The functions of the automatic detection response unit 241 and the server application cooperation unit 242 are the same as those of the automatic detection response unit 221 and the server application cooperation unit 224 shown in FIG. 1 except that the automatic detection response unit 241 and the server application cooperation unit 242 execute each function in a collective manner as a representative for each client application 22a whose client application information is registered in the client application management table 244. The client application registration unit 243 registers the client application information informed by each client application 22a in the client application management table 244. The result management unit 245 manages the execution result of the function received by the server application cooperation unit 242 and transmits the same to the client application 22a corresponding to the execution result. Note that the client application manager 24 can manage the client application 22a operating in other devices (for example, a mobile terminal 50 capable of wirelessly communicating with the client PC 20) besides the client application 22a operating on the same client PC 20.

On the other hand, each client application 22a has a UI control unit 222, a Web service execution unit 223, an external application execution unit 225, a setting information management file 226, a registration request unit 228, a result acquisition unit 229, and the like. The registration request unit 228 requests the client application registration unit 243 of the client application manager 24 to register the client application information of the client application 22a. The result acquisition unit 229 acquires the execution result of the function managed by the result management unit 245. Note that in the second embodiment, each client application 22a does not have functions corresponding to the automatic detection response unit 221 and the server application cooperation unit 224 because the client application manger 24 substitutes for the automatic detection response unit 221 and the server application cooperation unit 224 as described above.

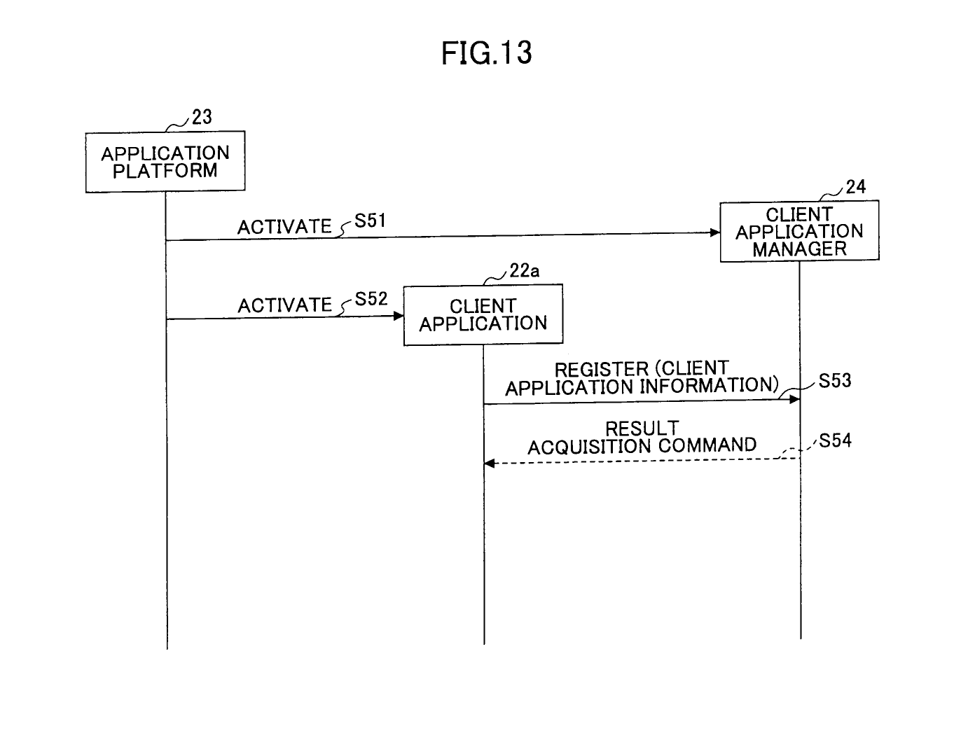

Next, a description is made of the processing procedure of a system according to the second embodiment. FIG. 13 is a sequence diagram for explaining processing for registering the client application in the client application manager.

In step S51 and step S52, the application platform 23 activates the client application manager 24 and each client application 22a in accordance with a user's instruction input or the like. Thus, the registration request unit 228 of the client application 22a requests the client application registration unit 243 to register the client application information of the client application 22a (S53).

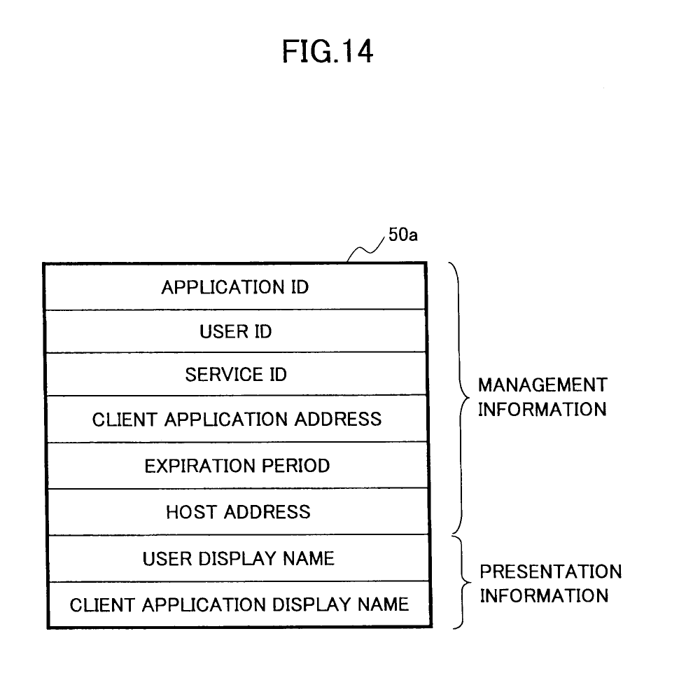

FIG. 14 is a diagram showing a configuration example of the client application information according to the second embodiment. In FIG. 14, client application information 50a is obtained by adding a host address to the client application information 50 according to the first embodiment (see FIG. 5) as a constituent of management information. The host address is the IP address of the client PC in which the client application 22a is installed.

In response to the request in step S53, the client application manager 24 registers the client application information in the client application management table 24 and informs the client application 22a of a result acquisition command (S54). Here, the result acquisition command is a command used when the client application manager 24 inquires of the client application 22a for the execution result of the function that the client application manager 24 receives the client application cooperation unit 126 of the server application 12.

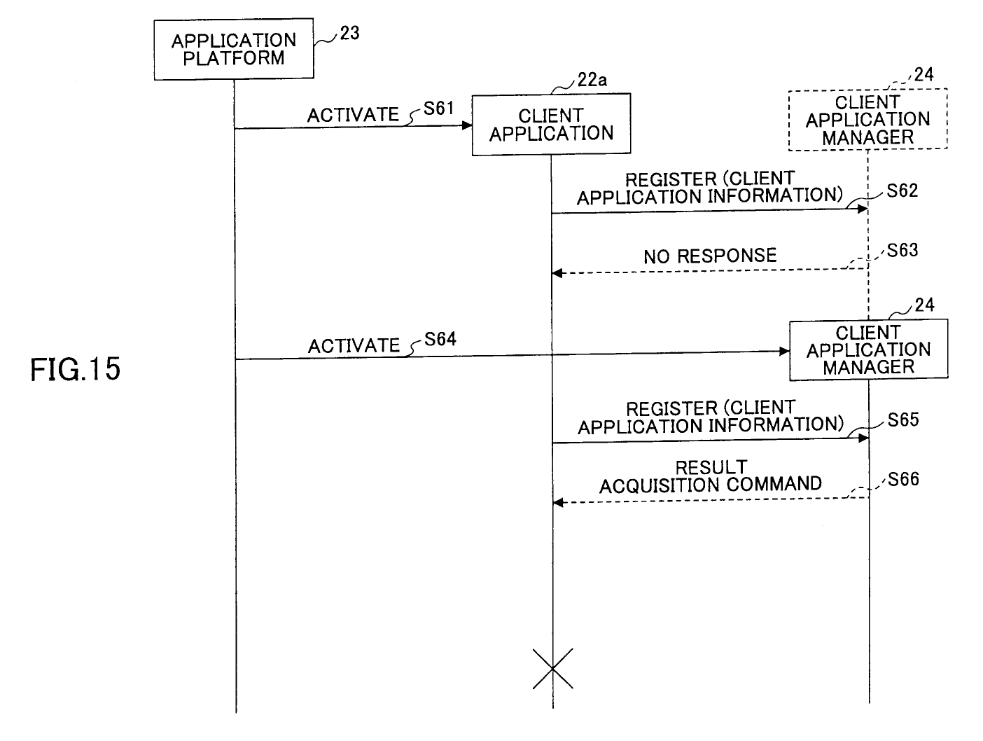

A description is now made of a modification of the sequence diagram shown in FIG. 13. FIG. 15 is a second sequence diagram for explaining processing for registering the client application in the client application manager.

In step S61, the application platform 23 activates only the client application 22a. Thus, the registration request unit 228 of the client application 22a requests the client application registration unit 243 to register the client application information 50a of the client application 22a (S62). However, since the client application manager 24 is not activated, a response to the request is not returned (S63). Therefore, the client application 22a makes the request for registering the client application information 50a in step S62 on a regular basis.

Then, the application platform 23 activates the client application manager 24 in response to a user's instruction input or the like (S64). Upon receipt of the request for registering the client application information 50a from the client application 22a (S65), the client application manager 24 registers the client application information 50a and returns the result acquisition command (S66).

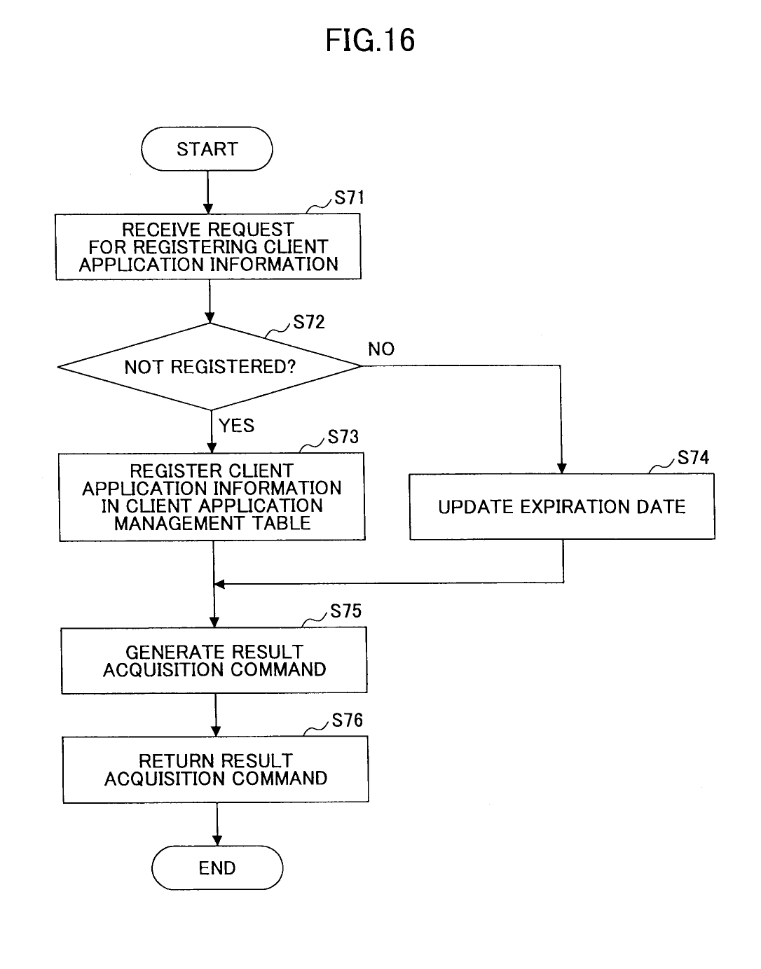

Next, a description is made of the details of the processing executed by the client application manager 24 in response to the request for registering the client application information 50a from the client application 22a in FIGS. 13 and 15. FIG. 16 is a flowchart for explaining the processing for registering the client application information by the client application manager.

Upon receipt of the request for registering the client application information 50a (S71), the client application manager 24 determines whether the received client application information 50a has been registered in the client application management table 244 (S72). If the client application information 50a has not been registered (Yes in S72), the client application manager 24 newly registers the client application information 50a in the client application management table 244 (S73).

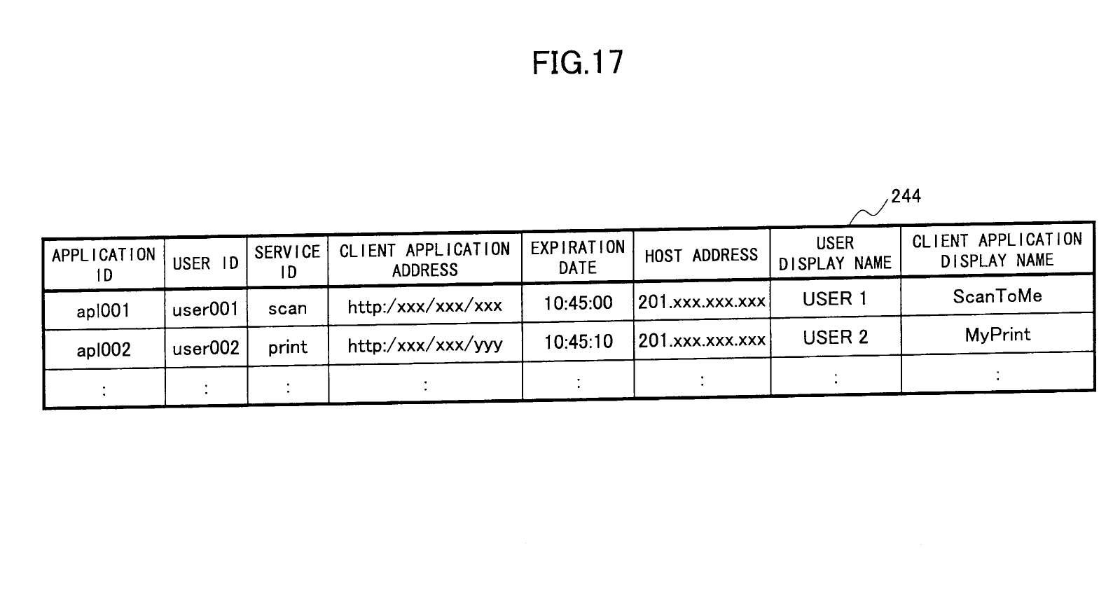

FIG. 17 is a diagram showing a configuration example of the client application management table managed by the client application manager. As shown in FIG. 17, the values of the items of the client application information are registered in the client application management table 244 as they are. However, the expiration period is replaced by an expiration date.

On the other hand, if the client application information 50a required to be registered has been registered (No in S72), the client application manager 24 updates the expiration date of the registered client application based on the present time and the expiration period (S74).

Then, the client application manager 24 generates the result acquisition command for the client application 22a (S75). For example, the result acquisition command is generated in such a manner that corresponding character strings are put in the angle brackets < > of the template character strings (forms) as follows.

http://<host address of the client application manager 24>:<port number of the client application manager 24>/<application ID of the client application 22a>+<host address of the client application 22a>/result

For example, if the host address of the client application manager 24 is “201.XXX.XXX.XXX,” the port number is “8080,” and the client application information 50a corresponding to the first record in FIG. 17 is registered, the following result acquisition command (1) is generated.

http://201.XXX.XXX.XXX:8080/ap1001/201.XXX.XXX.X XX/result (1)

The result acquisition command thus generated is a URL unique to each client application 22a.

Then, the generated result acquisition command is returned to the client application 22a (S76).

Next, the client application manager 24 acts for (collectively executes) the processing performed by each client application 22a in FIGS. 4 and 8 according to the first embodiment by using the client application information 50a registered in the client application management table 244.

For example, the automatic detection response unit 241 of the client application manager 24 responds to the client application detection message or the like sent from the client application detection unit 123 of the server application 12 and requests the client application registration unit 121 of the server application 12 to register the client application information 50a registered in the client application management table 244 (S12 through S14 in FIG. 4).

Furthermore, in step S25 in FIG. 8, the server application cooperation unit 242 of the client application manager 24 receives the request for sending the service setting information sent from the client application cooperation unit 126 of the server application 22. The server application cooperation unit 242 acquires the service setting information from the client application 22a corresponding to the application ID included in the request and returns the same to the client application cooperation unit 126. Note that the service setting information of each client application 22a may be acquired from each client application 22a at the same timing as the client application information 50a and registered in the client application management table 244.

Furthermore, in step S28 in FIG. 8, the execution result of the function sent from the client application cooperation unit 126 is received by the server application cooperation unit 242 of the client application manager 24 and stored in a storage area (for example, storage area corresponding to the URL of the result acquisition command informed to the client application 22a such as a folder, which is hereinafter referred to as a “result holding area”) different for each client application 22a inside the memory unit 203 and the auxiliary storage unit 202 by the result management unit 245.

Next, a description is made of a processing procedure for transmitting the execution result of the function held by the client application manager described above to the client application 22a corresponding to the execution result.

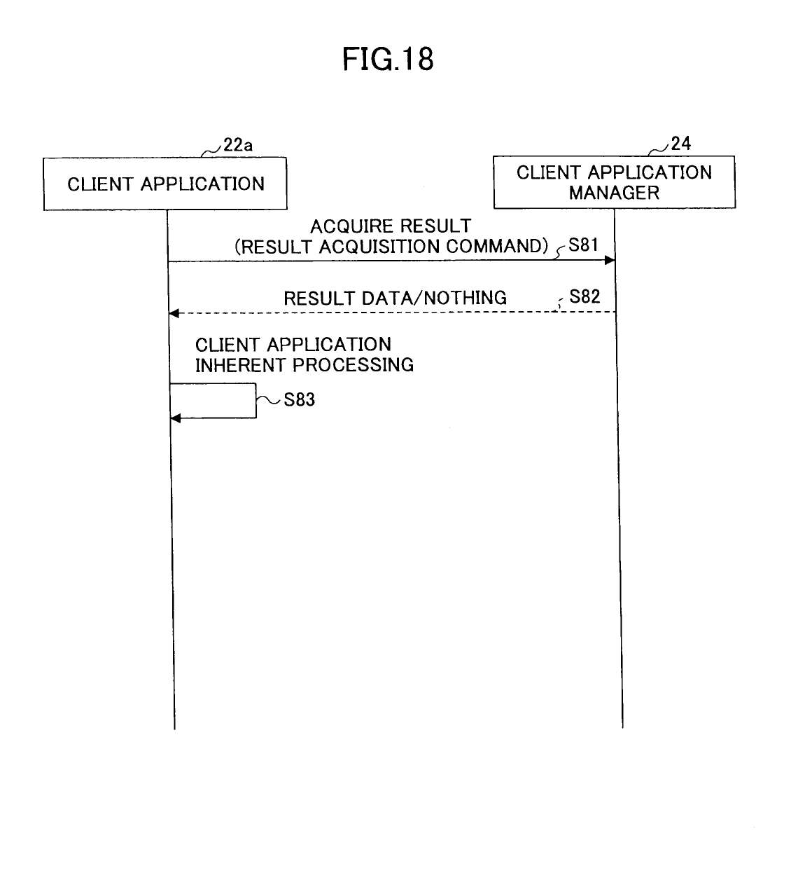

FIG. 18 is a sequence diagram for explaining the processing procedure for transmitting the execution result of the function to the client application.

The result acquisition unit 229 of the client application 22a issues the result acquisition command to the client application manager 24 on a regular basis after the registration of the client application information 50a (after the execution of the processing in FIG. 13 or FIG. 15) (S81). In response to the result acquisition command, the result management unit 245 of the client application manager 24 executes the following processing.

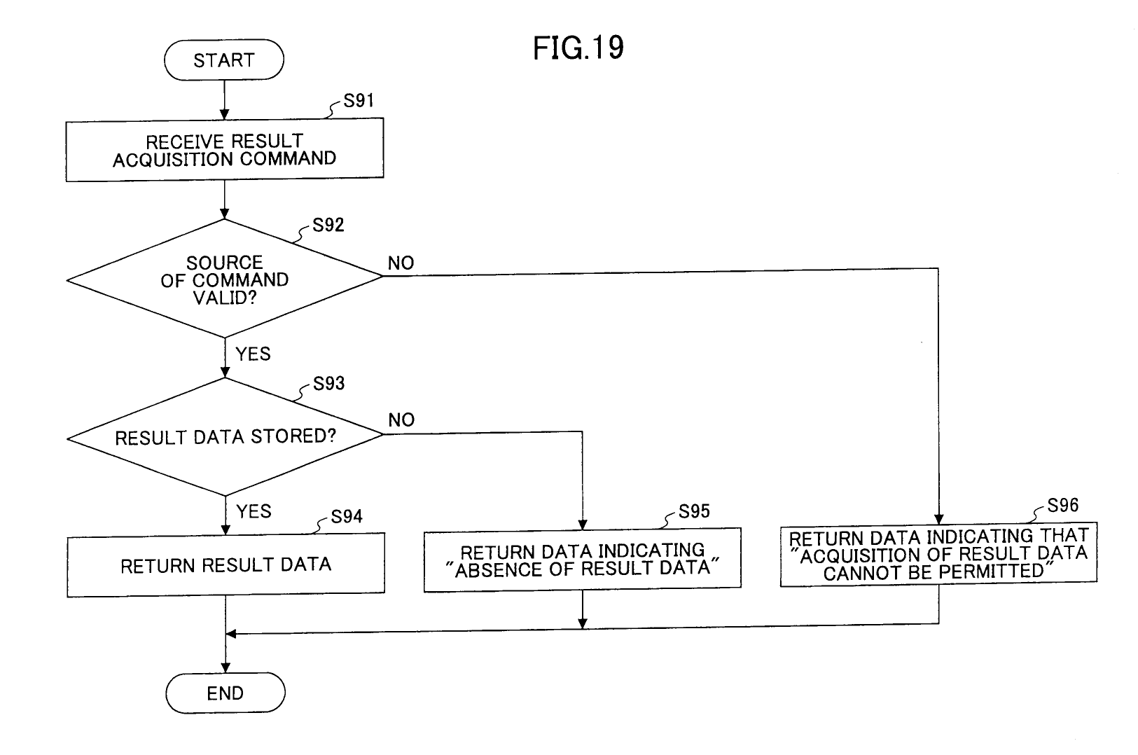

FIG. 19 is a flowchart for explaining the procedure of the processing when the result management unit executes in response to the result acquisition command.

In step S91, the result acquisition unit receives the result acquisition command (S91). Here, the result acquisition command is configured, for example, as follows.

http://201.XXX.XXX.XXX:8080/apl001/201.XXX.XXX.X XX/result?method=GET&apl_{—}id=apl001&host=201.XXX.XXX.XXX (2)

In the result acquisition command (2), the part after “?” is added by the result acquisition unit 229 of the client application 22a based on its own client application information (hereinafter referred to as “method information”) and is based on the following grammar.

method=Get&apl_{—}id=<application ID of the client application 22a>&host=<host address of the client application 22a>

Then, the result management unit determines the validity of the source of the result acquisition command (S92). Specifically, determination is made as to whether the result acquisition command is obtained from the source of the client application 22a. The determination is made based on the method information that must be added to the result acquisition command. If the application ID and the host address of the client application 22a included in the method information match those included before the method information (before “?”), the result management unit determines that the source of the result acquisition command is valid. Otherwise, the result management unit determines that the source of the result acquisition command is invalid.

If it is determined that the source of the result acquisition command is valid (Yes in S92), the result management unit determines whether the execution result (result data) of the function has been held (stored) in the result holding area corresponding to the URL specified by the result application command (S93). If the result data have been held in the result holding area, the result management unit returns the result data (S94). If the result data have not been held in the result holding area, the result management unit returns data indicating the absence of the result data (S95).

On the other hand, if it is determined that the source of the result acquisition command is invalid (No in S92), the result management unit returns data indicating that the acquisition of the result data cannot be permitted (S96).

The processing is now returned back to FIG. 18. When the result data are returned from the result management unit, the client application 22a executes an operating logic inherent in the client application 22a by using the result data (for example, scan image) (S83).

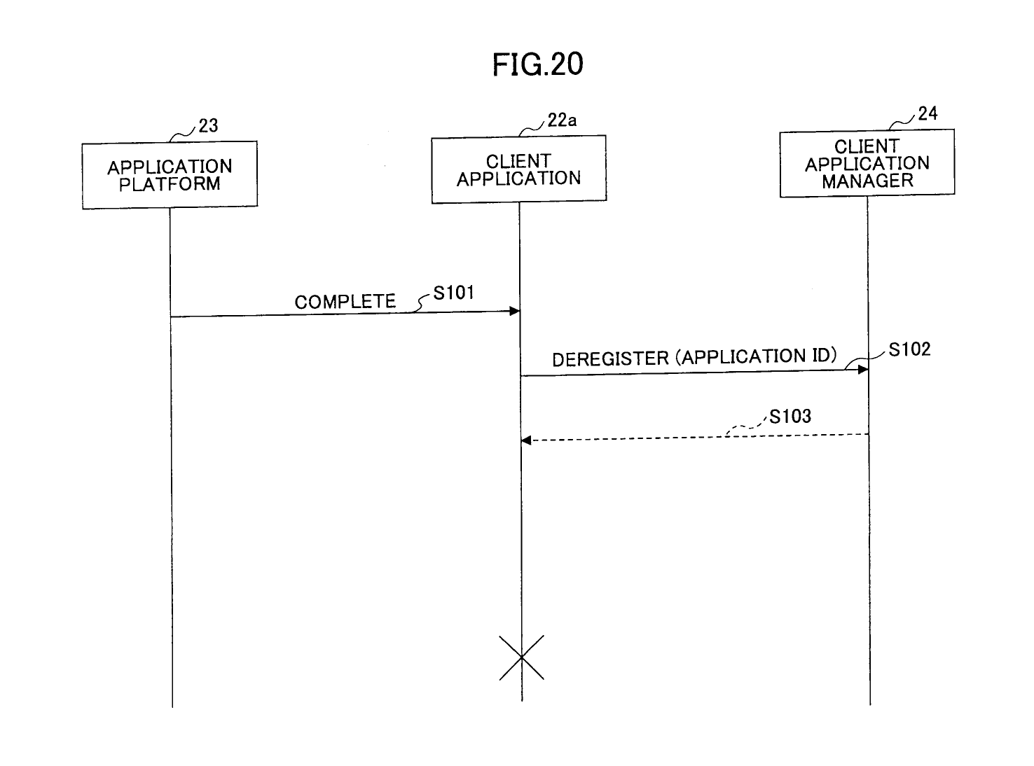

Then, a description is made of processing at the completion of the client application 22a. Here, the completion of the client application 22a refers to the time when the process or the thread of the client application 22a is completed (stopped). FIG. 20 is a sequence diagram for explaining a processing procedure at the completion of the client application.

When the application platform 23 instructs the client application 22a to complete its process or thread in accordance with a user's instruction input or the like, the registration request unit 228 of the client application 22a requests the client application manager 24 to execute deregistration processing using the application ID of the client application 22a as an argument (S102). The client application registration unit 243 of the client application manager 24 executes the deregistration processing of the client application 22a and informs the client application 22a of a result (S103).

Next, a description is made of the deregistration processing of the client application 22a executed by the client application registration unit 243 in FIG. 20.

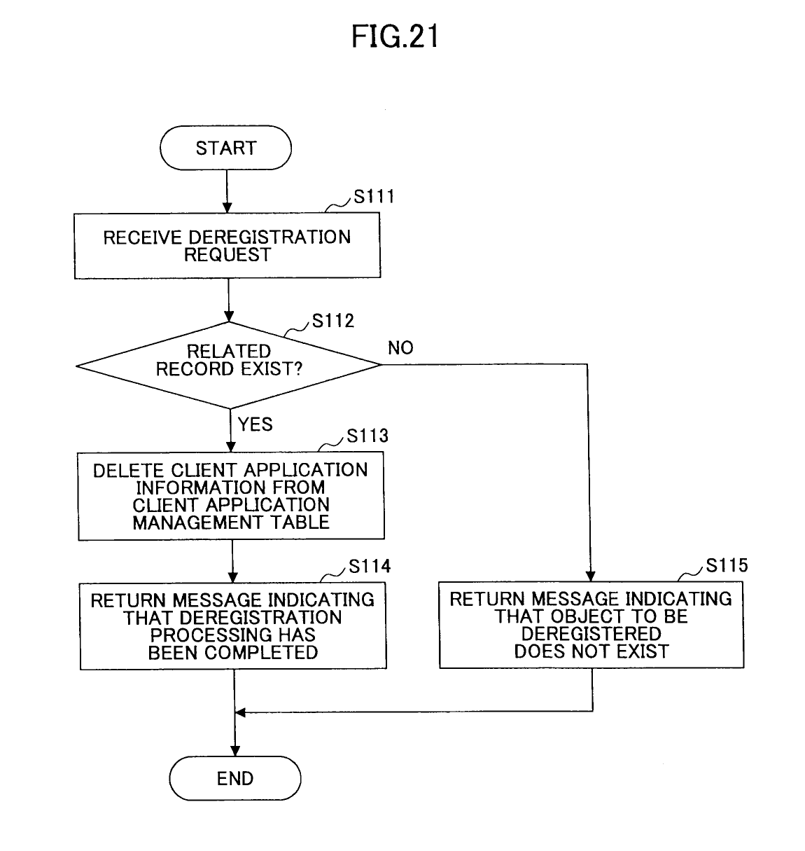

FIG. 21 is a flowchart for explaining the deregistration processing of the client application executed by the client application registration unit of the client application manager.

Upon receipt of the deregistration request together with an application ID from the registration request unit 228 of the client application 22a (S111), the client application registration unit 243 determines whether a record related to the application ID exists in the client application management table 244 (S112). If the record exists in the client application management table 244 (Yes in S112), the client application registration unit 243 deletes the record (client application information) (S113) and returns a message indicating that the deregistration processing has been completed to the registration request unit 228 (S114).

On the other hand, if the record does not exist in the client application management table 244 (No in S112), the client application registration unit 243 returns a message indicating that the object to be deregistered does not exist to the registration request unit 228 (S115).

With the processing shown in FIG. 21, the consistency between the activated client application 22a and the client application management table 244 can be appropriately ensured.

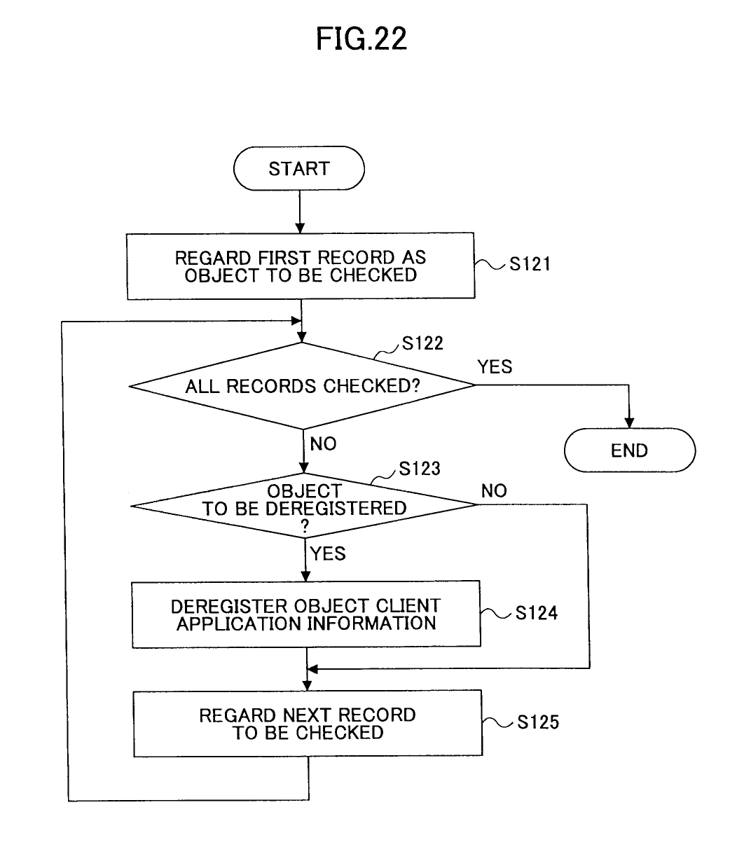

Note that the client application registration unit 243 of the client application manager 24 may delete expired client application information from the client application management table 244 on a regular basis. FIG. 22 is a flowchart for explaining the deletion processing of the expired client application information executed by the client application registration unit of the client application manager.

In step S121, the client application registration unit 243 regards the first record as an object to be checked among those registered in the client application management table 244. Then, the client application registration unit 243 determines whether all the records in the client application management table 244 have been checked (S122). If it is determined that all the records have been checked (Yes in S122), the processing shown in FIG. 22 is completed. If it is determined that all the records have not been checked (No in S122), the client application registration unit 243 determines whether the client application information 50a related to the record to be checked is an object to be deleted (S123). Specifically, the client application registration unit 243 determines whether the present time has elapsed the expiration date of the client application information 50a.

If the client application information 50a is the object to be deleted (the present time has elapsed the expiration date) (Yes in S123), the client application registration unit 243 deletes the client application information 50a from the client application management table 244 (S124). Next, the client application registration unit 243 regards the next record as an object to be checked (S125) and repeatedly performs the steps following step S122.

With the execution of the processing shown in FIG. 22 and the processing shown in FIG. 13 or the processing shown in FIG. 15 on a regular basis, the consistency between the activated client application 22a and the client application management table 244 can be appropriately ensured even if the processing shown in FIG. 21 is not executed.

As described above, according to the second embodiment, the client application manager 24 collectively performs communication with the image forming apparatus 10. Accordingly, the exclusively-used number of communication ports can be reduced. In other words, in the first embodiment, the same communication port cannot be shared between the client applications 22. Thus, the exclusively-used number of communication ports increases in proportion to the number of the client applications 22. On the other hand, in the second embodiment, a communication module can be shared. Therefore, the minimum number of the communication ports can be used free from an increase in the number of the client applications 22.

Furthermore, in the second embodiment, some of the functions installed in each client application 22 in the first embodiment are implemented by the client application manager 24. Therefore, each client application 22a can be lightened. Accordingly, the distribution size of each client application 22a can be reduced.

Furthermore, each client application 22a is not required to have data exchanges with the image forming apparatus 10. Accordingly, development resources can be concentrated on the original functions (such as an operating logic) of the client application 22.

On the other hand, in the case of the configuration of the client application 22 according to the first embodiment, each client application 22 has a high degree of independence and singly completes the functions including communication with the image forming apparatus 10, the execution of the operating logic, and the like. Accordingly, each client application 22 can be independently installed and used as it is without depending on the installation of a platform such as the client application manager 24.

Note that an apparatus capable of installing a function corresponding to the server application 12 is not limited to the image forming apparatus. An apparatus capable of providing a predetermined service (function) via a network (for example, an apparatus having a Web service) could install the function corresponding to the server application 12.

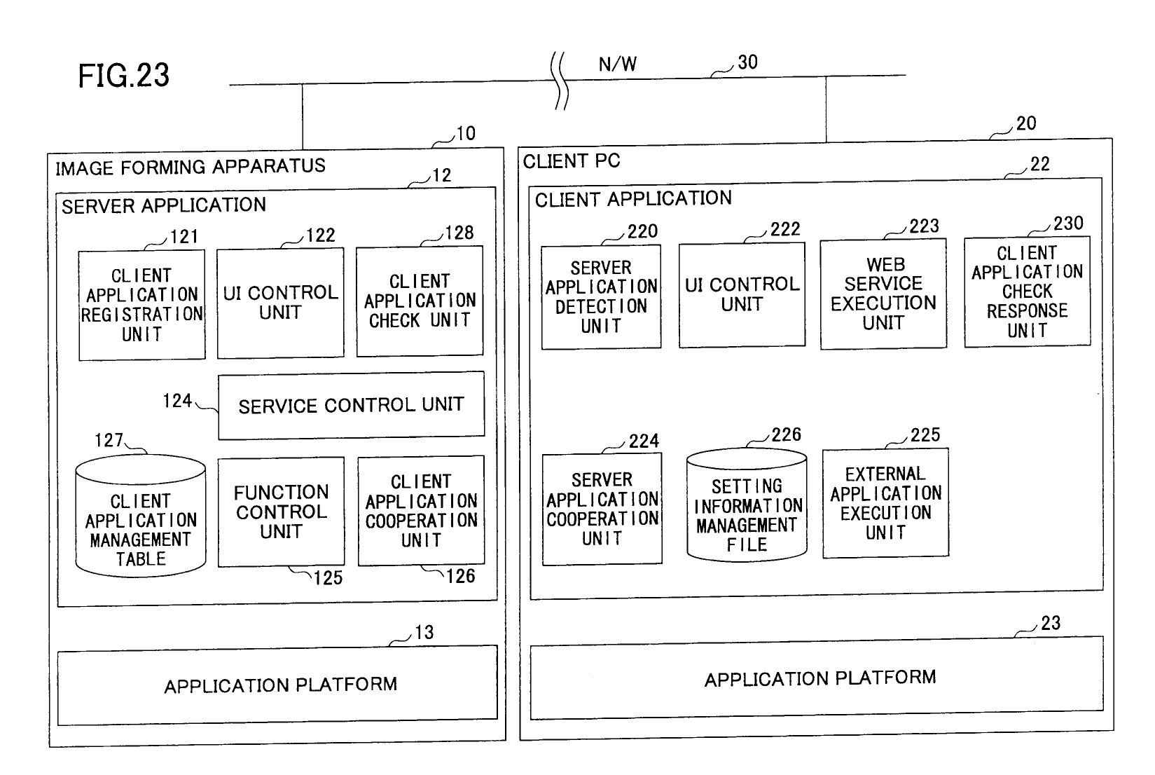

Next, a description is made of a third embodiment as a modification of the embodiment of the present invention. FIG. 23 is a diagram showing a system configuration example according to the third embodiment. In FIG. 23, components the same as those of FIG. 1 are denoted by the same reference numerals.

The third embodiment is greatly different from the first embodiment in that the client PC 20 has a server application detection unit 220 and a client application check response unit 230, and the image forming apparatus 10 has a client application check unit 128 instead of the client application detection unit 123.

The client application check unit 128 confirms (checks) the existence of the client application 22 registered in the client application management table 127.

The server application detection unit 220 detects the existence of the server application 12 on the network 30 and sends the client application information to the detected server application 12. The server application cooperation unit 224 sends the service setting information and receives information related to the execution result of the service in response to a request from the client application cooperation unit 126. The service setting information is registered in the setting information management file 226. The client application check response unit 230 responds to a check message for confirming the existence of the client application 22 by the client application check unit 123 to inform the existence of the client application 22 (inform that the client application 22 has been activated).

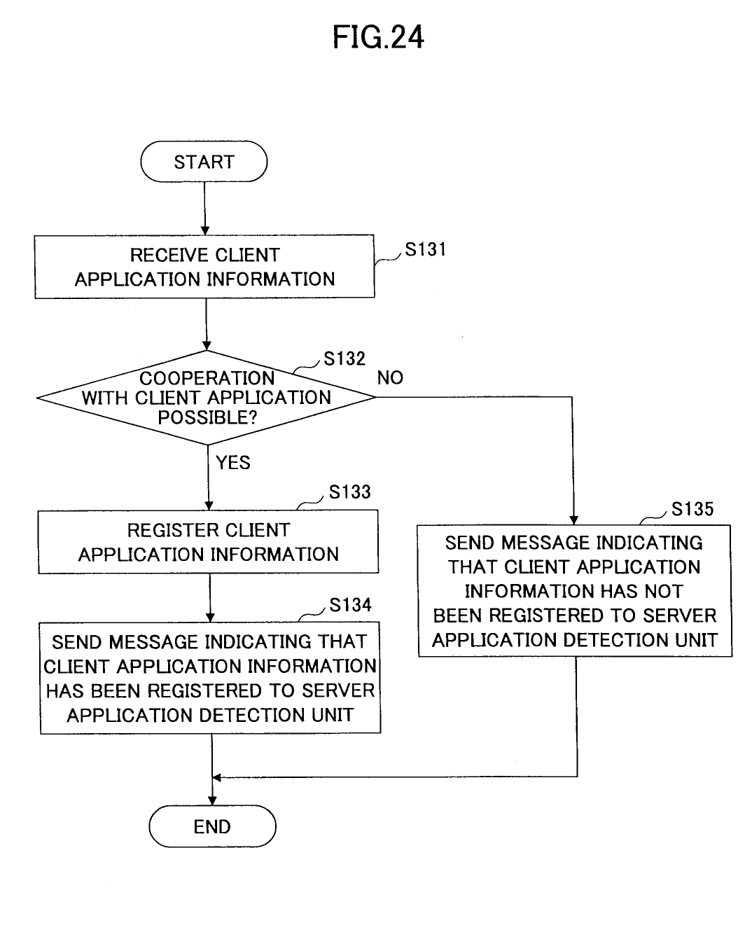

Next, a description is made of the processing procedure of a system according to this embodiment. FIG. 24 is a flowchart for explaining the processing procedure at the registration of the client application information in the image forming apparatus.

When the client application 22 is activated on the client PC 20, the server application detection unit 220 of the client application 22 automatically detects the server application 12 on the network 30 on a regular basis. Specifically, the server application detection unit 220 automatically detects the existences of the image forming apparatus 10 and the server application 12 through a broadcast or the like and sends the client application information to the detected server application 12. Note that the client application information is stored in the auxiliary storage unit 202 so as to be associated with each client application 22.

In step S131, the client application registration unit 121 of the server application 12 receives the client application information.

Subsequently, the client application registration unit 121 determines the possibility of cooperation with the client application 22 related to the received application 50 (S132). Specifically, the client application registration unit 121 determines whether the function corresponding to the service ID included in the application information 50 can be executed. The determination may be made based on, for example, the information on a list of the functions that can be executed, a list of the service IDs that can be handled, or the like stored in the HDD 114.

Note that as a part of the application information 50, information on execution environments for the function, such as the model name and the version of the image forming apparatus 10, may be included in the service ID or may be provided aside from the service ID. In this case, the information on the execution environments may also be used as information for making a determination whether the function can be executed.

If it is determined that the cooperation with the client application can be executed (Yes in S132), the client application registration unit 121 registers the client application information 50 in the client application management table 127 (S133).

Then, the client application registration unit 121 sends a message indicating that the client application information 50 has been registered to the server application detection unit 221 of the client application 22 corresponding to the registered client application information 50 (S134).

On the other hand, if it is determined that the cooperation with the client application cannot be executed (No in S132), the client application registration unit 121 sends a message indicating that the client application information 50 has not been registered to the server application detection unit 220 as the sending source of the client application information 50 (S135).

Note that in steps S134 and S135, the client application registration unit 121 sends the identification information (IP address, equipment name, or the like) of the image forming apparatus 10 to the server application detection unit 220.

Upon receipt of the information (information in step S134 or step S135) from the server application 12 of each image forming apparatus 10, the server application detection unit 220 of the client application 22 stores the identification information of the image forming apparatus 10 for which the registration of the client application is made successful in the memory unit 203 or the auxiliary storage unit 202 as registration destination information. The UI control unit 222 causes the registration destination information to be displayed on the display unit 206 automatically or in accordance with a user's instruction input.

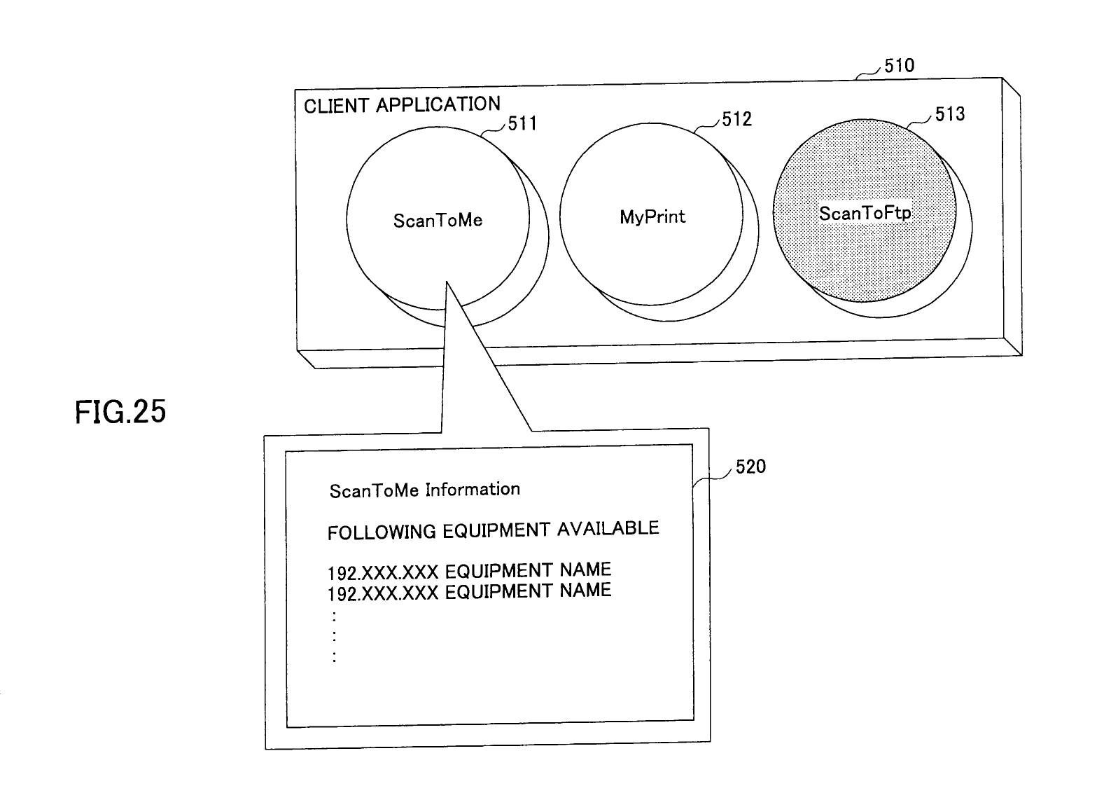

FIG. 25 is a diagram showing a display example of registration destination information in the client PC. In FIG. 25, a client application list screen 510 displays a list of the icons of the client applications 22 activated in the client PC 20. For example, when the menu item of “a list of registration destinations” is selected in the context menu displayed when the icon 511 of the ScanToMe application is right-clicked, the UI control unit 222 causes a registration destination list screen 520 to be displayed on the display unit 206. By referring to the registration destination list screen 520, the user is allowed to recognize which image forming apparatus 10 can be used for executing the client application 22. Note that the icon 513 of a ScanToFTP application is grayed out. This represents a display example of the icon when the ScanToFTP application is not registered in any image forming apparatus 10.

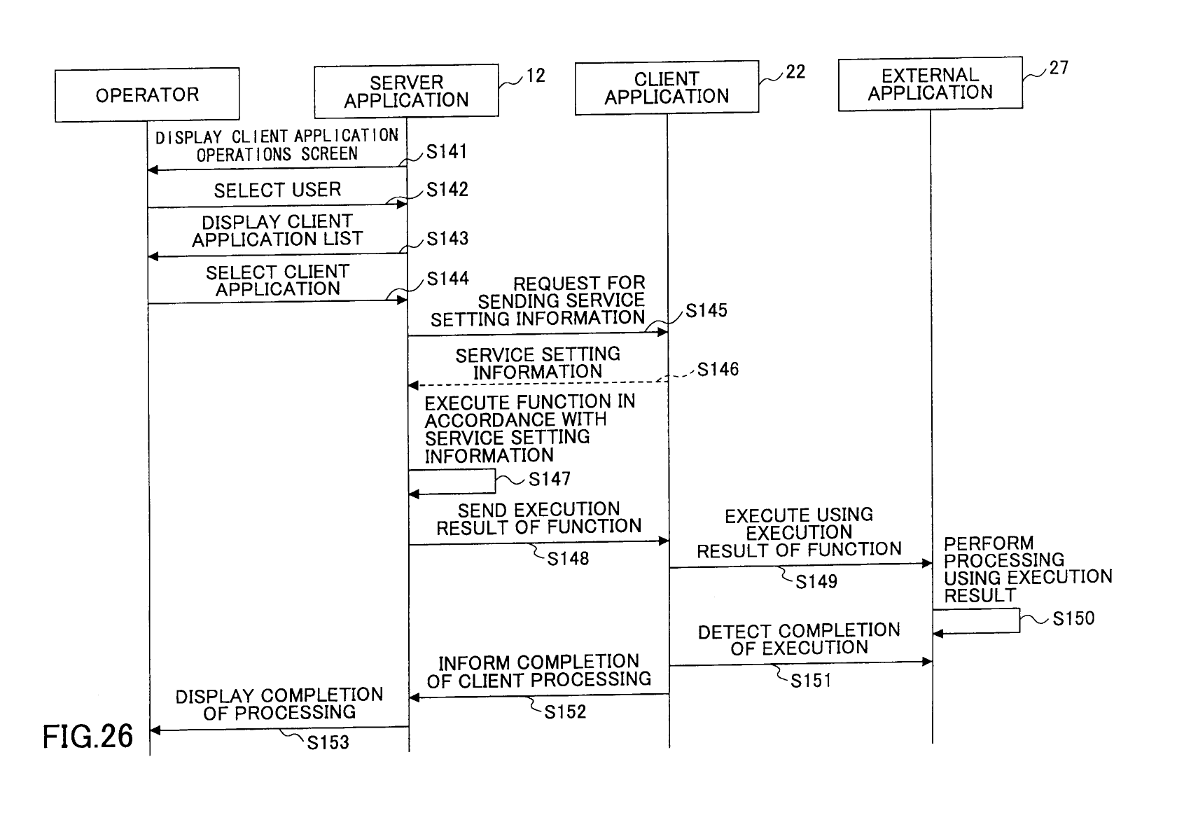

Next, a description is made of a processing procedure when the client application 22 is used (executed). FIG. 26 is a sequence diagram for explaining the processing procedure at the execution of the client application 22.

For example, when an operator of the image forming apparatus 10 presses a predetermined key (key corresponding to the server application 12) on the operations panel 16, the UI control unit 122 of the server application 12 causes a client application operations screen to be displayed on the operations panel 16 (S141).

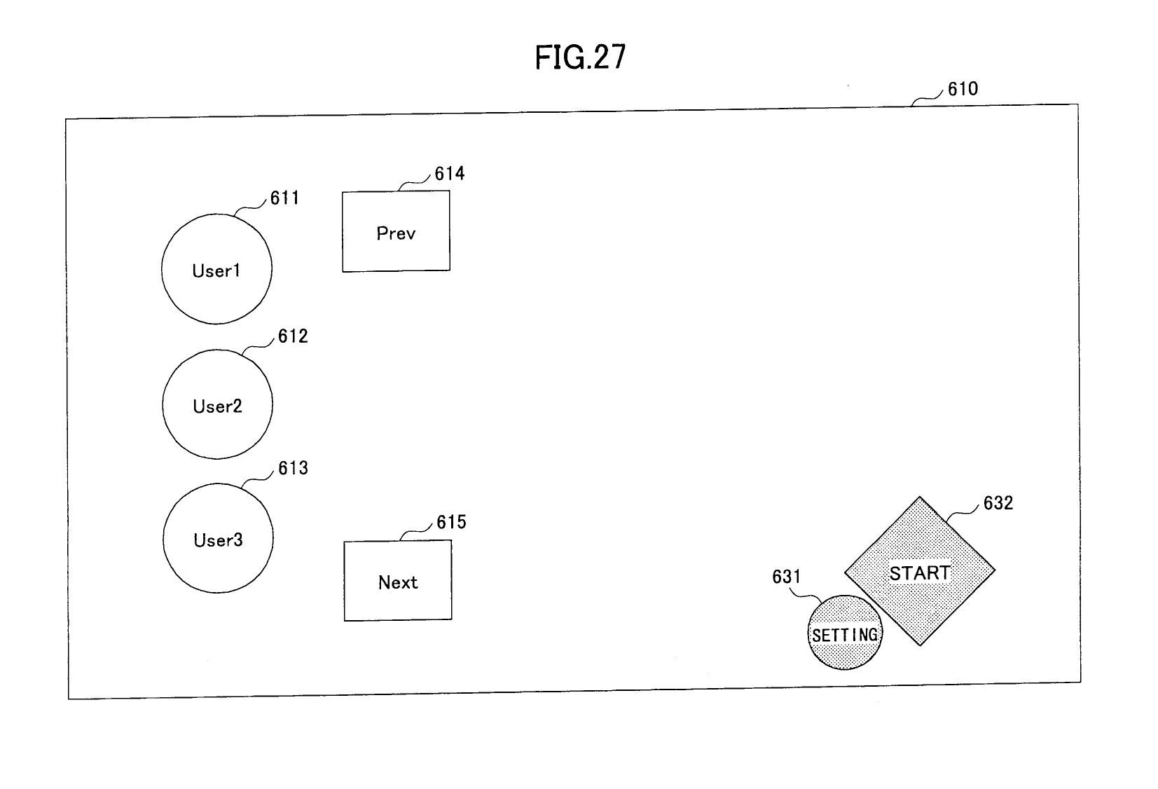

FIG. 27 is a diagram showing a display example of the initial state of the client application operations screen. In FIG. 27, selection buttons 611 through 613 are arranged for each user (user ID) on the client application operations screen 610. The user to be displayed can be changed when a Prey button 614 or a Next button 615 is pressed. Furthermore, the arrangement order of the selection buttons can be sorted in accordance with the use efficiency of the image forming apparatus 10, an alphabetical order, or the like. Note that a list of the user IDs displayed on the client application operations screen 610 is stored in advance in the HDD 14. Furthermore, in FIG. 27, a setting button 631 and a start button 632 are grayed out. This represents that these buttons cannot be pressed at this stage.

Then, when the selection button is selected by the operator (S142), the UI control unit 122 retrieves from the client application management table 127 the client application information having a user ID matching the user ID related to the selection button thus selected and causes a list (client application list) of the client application display names of the retrieved client application information to be displayed on the client application operations panel 610 (S143). Accordingly, the client application list displays only the client applications 22 that the operator can use. In other words, since the client application 22 that the operator cannot use is not displayed, operability can be improved.

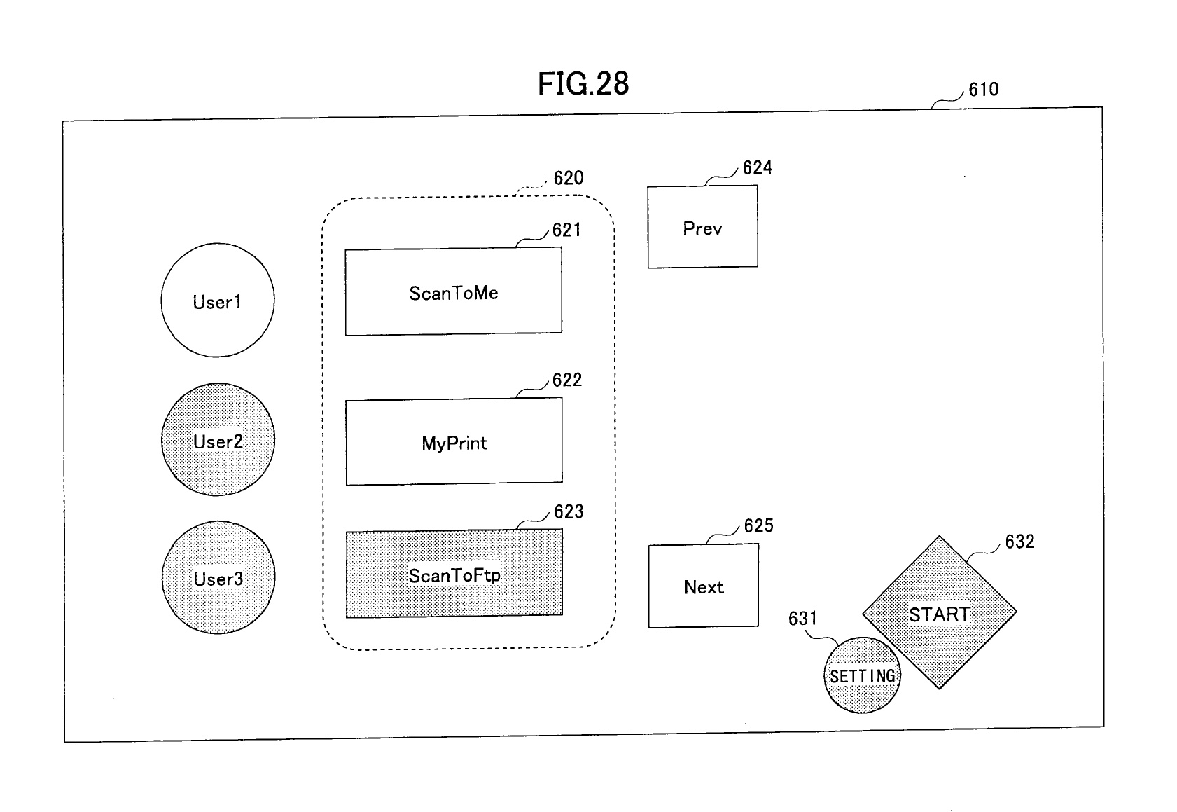

FIG. 28 is a diagram showing a display example of the client application operations screen when the user is selected. In the client application operations screen 610 shown in FIG. 28, selection buttons (621 through 623) are displayed corresponding to the three client applications 22. The client application 22 to be displayed can be changed when a Prey button 624 or a Next button 625 is pressed. Furthermore, the selection buttons 621 through 623 may be sorted in various ways in the same manner as the user ID.

Meanwhile, in FIG. 28, the selection button 623 of the ScanToFTP application is grayed out. This represents a display example of the selection button when the function (for example, FTP communication function) corresponding to the service ID (“scantoftp”) related to the ScanToFTP application cannot be executed due to the occurrence of a failure or the like. That is, when displaying the client application list, the UI control unit 211 confirms whether the function corresponding to the service ID is being normally operated in the image forming apparatus 10 based on the service ID included in the client application information of each client application 22. Note that when the grayed-out selection button 623 is pressed, the UI control unit 211 displays a reason why the client application cannot be executed.

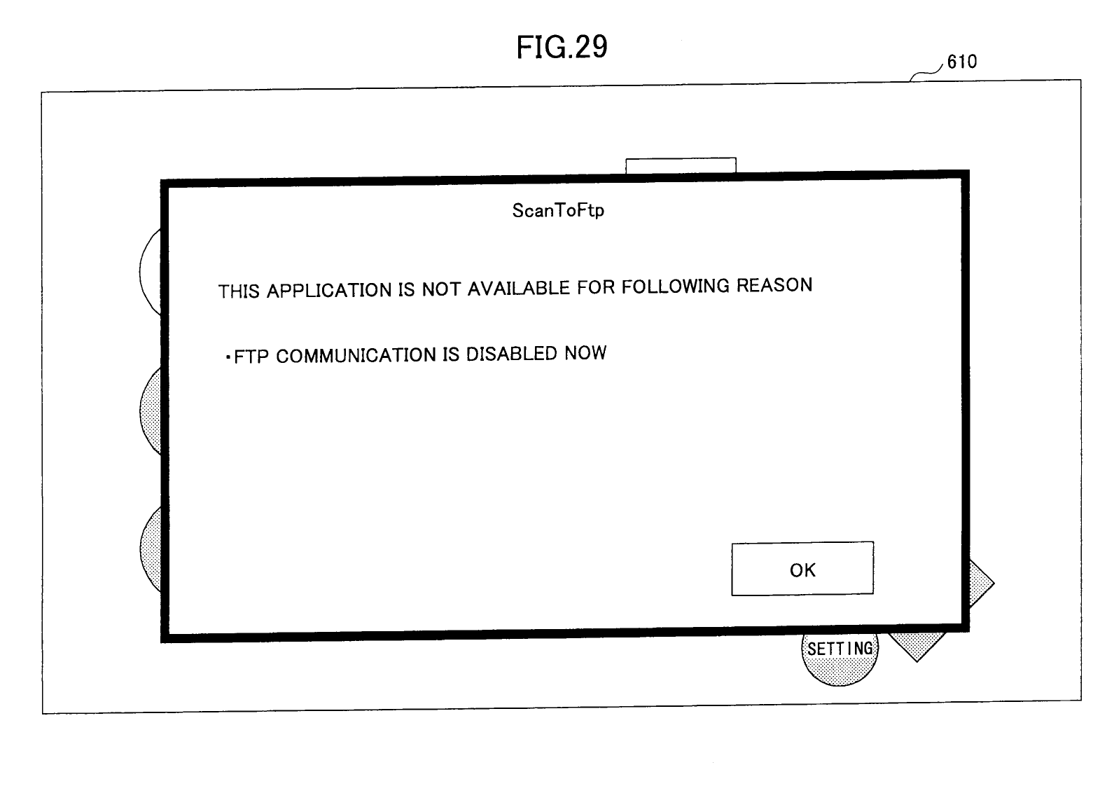

FIG. 29 is a diagram showing a display example showing a reason why the client application cannot be executed. As a reason why the ScanToFTP application cannot be executed, FIG. 29 shows that the FTP communication function is disabled.

Next, when the selection button of the client application 22 to be executed is selected in the client application list 620, the state of the client application operations screen 610 is changed as follows.

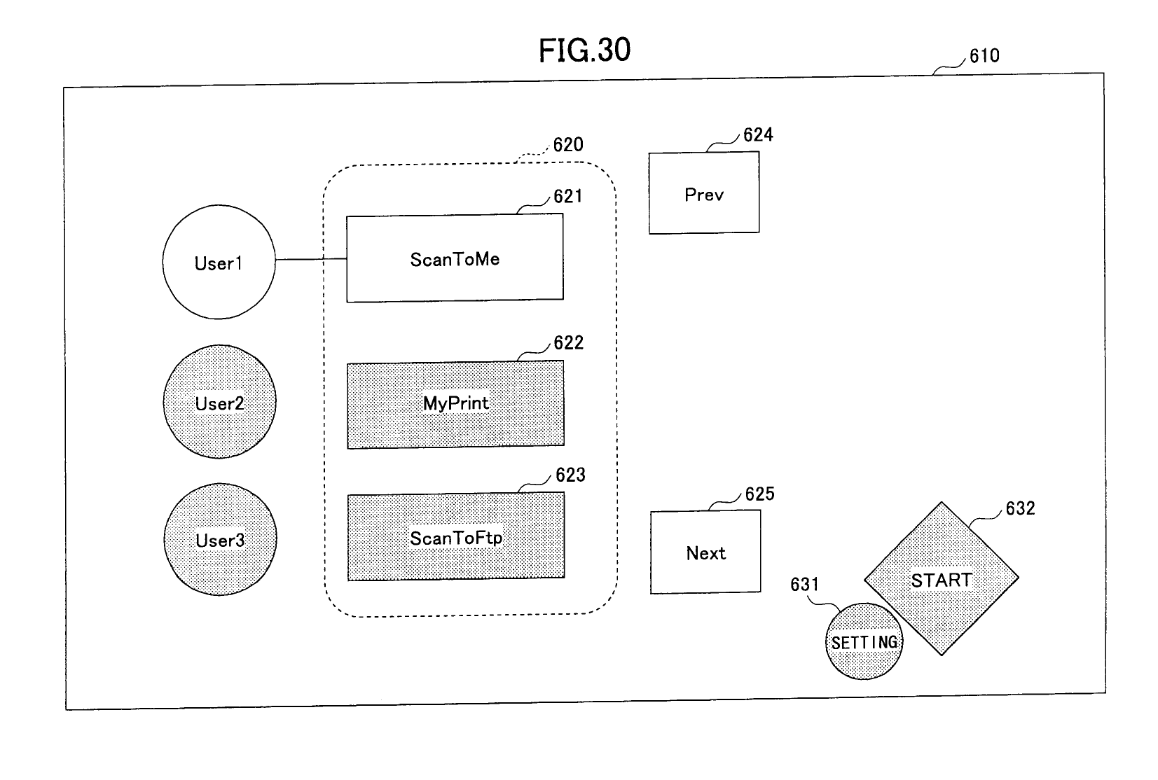

FIG. 30 is a diagram showing a display example of the client application operations screen when the client application is selected. In the client application operations screen 610 shown in FIG. 30, the selection button 621 of the ScanToMe application is selected. When the selection button 621 is selected, the selection buttons (622 and 623) of the other client applications 22 are grayed out. Furthermore, the grayout states of the setting button 631 and the start button 632 are cleared, whereby the selection of these buttons is made possible.

When the operator presses the start button 632 in this state (S144), the UI control unit 122 informs the service control unit 124 of the service ID contained in the client application information of the selected client application 22 (hereinafter referred to as a “current client application”). The service control unit 124 performs processing control in accordance with the informed service ID. In other words, the service control unit 124 understands the meaning of the service ID and knows which function should be executed for each service ID. Note that the association of the service ID with the function to be executed may be incorporated in the service control unit 124 as logic or stored in the HDD 114 as a definition file.

For example, when it is required that the service setting information be acquired from the current client application, the service control unit 124 instructs the client application cooperation unit 126 to acquire the service setting information (for example, setting information for the scanning function when the service ID is “scan” and setting information for the printing function when the service ID is “print”) corresponding to the service ID. At this time, the client application address of the current client application is informed to the client application cooperation unit 126. In accordance with the instruction, the client application cooperation unit 126 requests the current client application 22 to send the service setting information based on the client application address (S145).

Upon receipt of the request, the server application cooperation unit 224 of the current client application acquires (reads) the service setting information from the setting information management file 226 corresponding to the current client application and returns the service setting information to the client application cooperation unit 126 (S146).

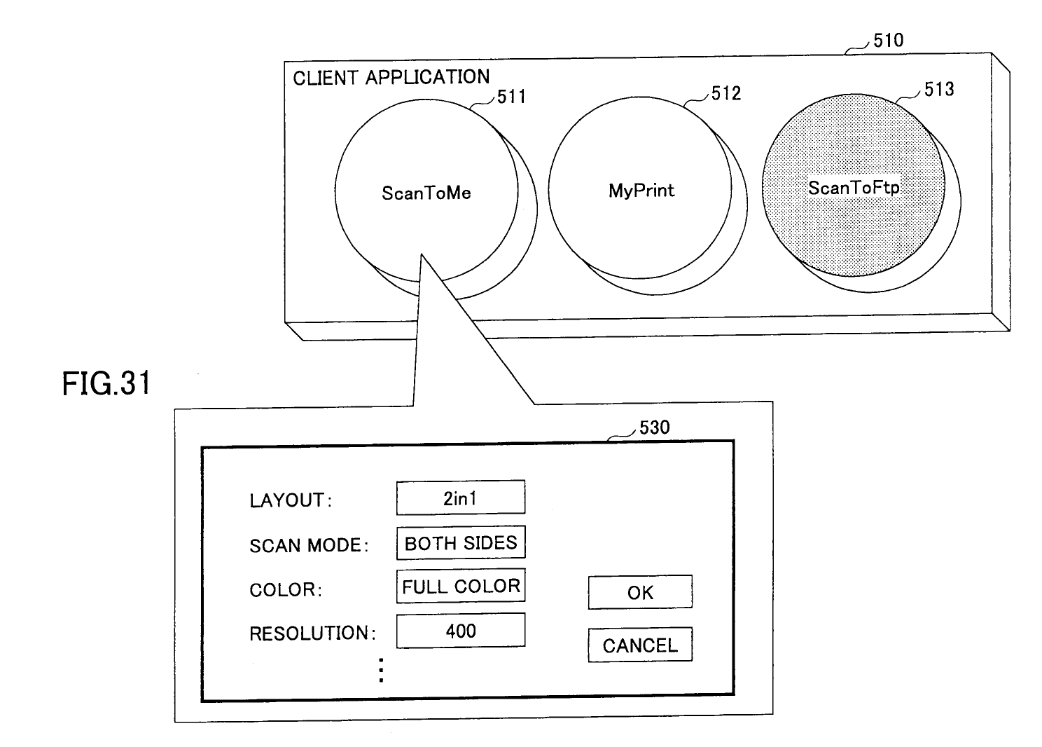

Note that the service setting information is input in the client PC 20, for example, in the following manner. FIG. 31 is a diagram for explaining an example of inputting the service setting information in the client PC.

For example, when the menu item of “input setting information” is selected in the context menu displayed when the icon 511 of the ScanToMe application is right-clicked, the UI control unit 222 causes a setting information input screen 530 corresponding to the client application 22 (ScanToMe application) to be displayed on the display unit 206. The UI control unit 222 stores information input on the setting information input screen 530 in the setting information management file 226 of the ScanToMe application.

The service setting information received by the client application cooperation unit 126 is informed to the service control unit 124. The service control unit 124 invokes the function control unit 125 corresponding to the service ID and informs the function control unit 125 of the service setting information.

Note that the service setting information may be sent to the client application registration unit 121 together with the client information 50 at the detection of the client application 22 and registered in the client application management table 127. In this case, it is not required that the service setting information be acquired in steps S145 and S146. However, from the viewpoint of the fact that the capacity of the memory of built-in type equipment such as the image forming apparatus 10 is small, it is desired that only the client application information 50 be registered in the client application management table 127.

Furthermore, the service setting information may be input on the side of the image forming apparatus 10. For example, when the setting button 631 is pressed before the start button 632 is pressed, the UI control unit 122 causes a setting screen corresponding to the service ID related to the current client application to be displayed on the operations panel 16.

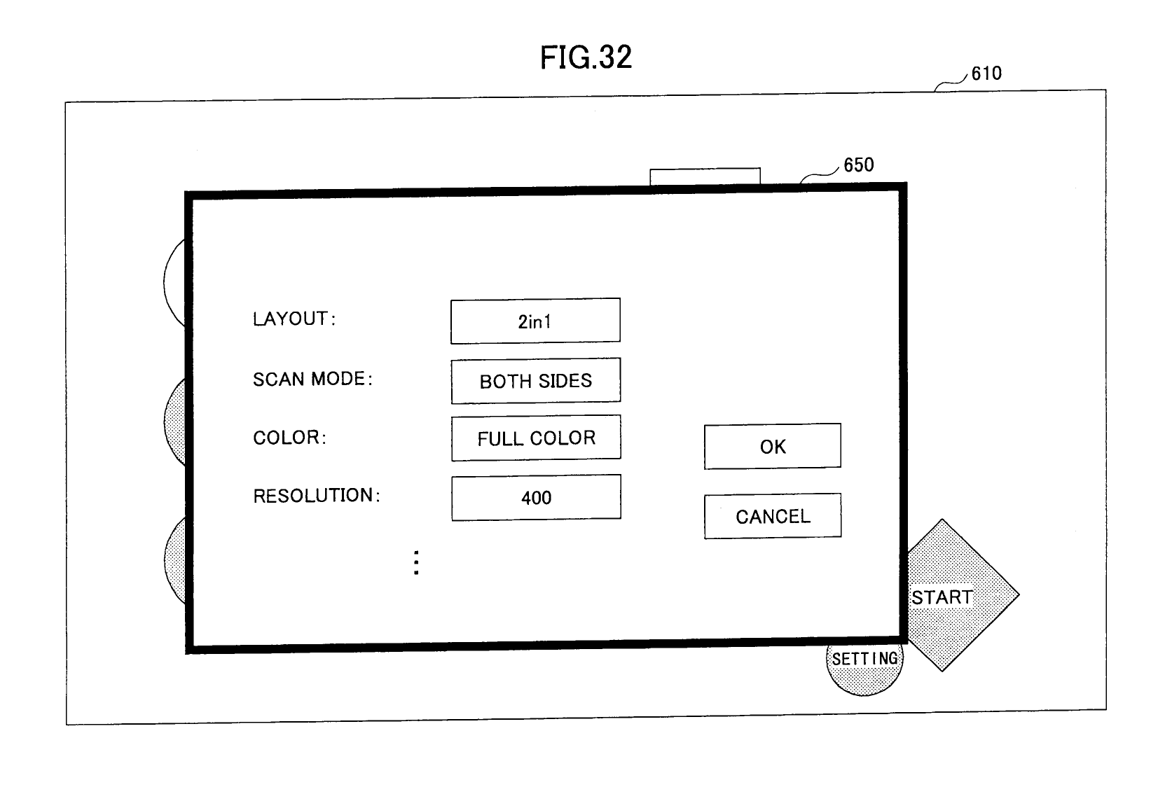

FIG. 32 is a diagram showing a display example of the setting screen. The setting screen 650 in FIG. 32 is a setting screen for executing the scanning function. Also, when the service setting information is input in the setting screen 650, it is not required that the service setting information be acquired in steps S145 and S146.

Subsequently, the invoked function control unit 125 executes the function (scanning function, printing function, or the like) based on the service setting information (S147). For example, the function control unit 125 corresponding to the scanning function causes the scanner 17 to scan a document set on the image forming apparatus 10 by the user and outputs resulting image data to the service control unit 124 as the execution result of the function. Furthermore, the function control unit 125 corresponding to the printing function causes the printer 18 to print an object print file received from the client application 22 together with the service setting information and outputs information indicating the result (for example, success or failure of the printing) to the service control unit 124 as the execution result of the function.

The service control unit 124 instructs the client application cooperation unit 126 to send the execution result of the function to the current client application. The client application cooperation unit 126 sends the execution result of the function (service) to the server application cooperation unit 224 in accordance with the instruction (S148).

When the execution result of the function is received by the server application cooperation unit 224, the current client application executes processing in accordance with an operating logic installed in the current client application. For example, the current client application stores the image data (scan data) included in the execution result of the function in a storage destination registered in the client information of the service setting information 226a. Furthermore, the current client application causes the printing result included in the execution result of the function to be displayed on the display unit 206. Furthermore, if the current client application cooperates with the external application 27, the external application execution unit 225 of the current client application invokes the external application 27 and informs the external application 27 of the execution result of the function (S149). The invoked external application 27 executes processing inherent in the external application 27 (S150). The processing of the external application 27 is not limited to a predetermined one, but it is varied depending on a solution, a workflow, or the like desired to be implemented. For example, the scan image may be subjected to an OCR (Optical Character Reader), or it may be registered in a predetermined document management DB.

When the external application execution unit 225 detects the execution of the processing of the external application 27 (S151), the server application cooperation unit 224 informs the client application cooperation unit 126 that the processing of the current client application (client processing) has been completed (S152). When the client application cooperation unit 126 receives the information on the client processing, the UI control unit 122 causes the completion of the processing of the current application to be displayed on the operations panel 16 (S153).

Meanwhile, the client application 22 is not necessarily activated after having being registered by the client application registration unit 123. For example, the client application 22 may be stopped due to user's convenience or the like. The client PC 20 may be turned off. Accordingly, an inconsistency between the client application management table 127 and the client application 22 actually available may occur. As a result, the client application 22 selected from the client application list displayed on the operations panel 16 may not be executed.

As described above, according to the third embodiment, any client application 22 (workflow) in which the function of the image forming apparatus 10 is incorporated can be executed through the operations panel 16 of the image forming apparatus 10. At this time, as for the function of the image forming apparatus 10, the setting information (service setting information) is held on the basis of the client application 22 associated with the user. Therefore, more private (user-inherent) workflow can be implemented.

Furthermore, operations for executing each client application 22 are uniformalized (selection from the client application list and pressing of the start key) even if a different function or a different workflow is implemented. Therefore, the operator is not required to memorize the operations for each function and each workflow.

Moreover, the image forming apparatus 10 is only required to provide a simple image input/output function, and additional processing is executed by the client PC 20. Therefore, the complexity of the functions of the image forming apparatus 10 can be avoided. Also, complicated functions can be installed in the client PC 20 that is less restrictive in all respects.

Furthermore, each client application 22 is automatically detected and registered in the image forming apparatus 10. Accordingly, the user is not required to register each client application 22 in the image forming apparatus 10. Furthermore, the client application 22 on the absent client PC can be excluded from objects to be registered. Therefore, when the client application 22 is selected in the image forming apparatus 10, presentation of unnecessary candidates to be executed can be avoided. The present invention is not limited to the specifically disclosed embodiments, and variations and modifications may be made without departing from the scope of the present invention.

The present application is based on Japanese Priority Applications No. 2008-237122 filed on Sep. 16, 2008 and No. 2008-237123 filed on Sep. 16, 2008, the entire contents of which are hereby incorporated herein by reference.

1-18. (canceled)

19. A printing system comprising:
a client terminal including a client information transmitter configured to send client information including user identification information and client identification information, the client information sent by the client information transmitter being registered in a storage medium; and
an image forming apparatus, the image forming apparatus including:
a print data receiver configured to acquire print data from the client terminal based on the client identification information of the client information, which includes as the user identification information, user identification information of a login user of the image forming apparatus, and
a printer configured to print the print data.

20. The printing system according to claim 19, wherein the image forming apparatus further includes a setting information receiver configured to acquire setting information including conditions to execute printing of the acquired print data.

21. The printing system according to claim 20, wherein the setting information receiver is configured to acquire the setting information from the client terminal based on the client information, which includes as the user identification information user identification information of the login user of the image forming apparatus.

22. The printing system according to claim 20, wherein the setting information includes a name of the print data.

23. The printing system according to claim 19, wherein the client identification information is an IP address of the client terminal.

24. The printing system according to claim 19, wherein the client terminal includes the storage medium.

25. The printing system according to claim 19, wherein the image forming apparatus includes the storage medium.

26. The printing system according to claim 19, wherein the client terminal and the image forming apparatus are operatively connected via a network, the client information and the print data each passing over the network.

27. A method comprising:
sending, using a client information transmitter of a client terminal, client information including user identification information and client identification information, the sent client information being registered in a storage medium;
acquiring, using a print data receiver of an image forming apparatus, print data from the client terminal based on the client identification information of the client information, which includes as the user identification information, user identification information of a login user of the image forming apparatus; and
printing, using a printer of the image forming apparatus, the print data.

28. The method according to claim 27, further comprising acquiring, using a setting information receiver of the image forming apparatus, setting information including conditions to execute printing of the acquired print data.

29. The method according to claim 28, wherein said acquiring includes acquiring the setting information from the client terminal based on the client information, which includes as the user identification information user identification information of the login user of the image forming apparatus.

30. The method according to claim 28, wherein the setting information includes a name of the print data.

31. The method according to claim 27, wherein the client identification information is an IP address of the client terminal.

32. The method according to claim 27, wherein the client terminal includes the storage medium.

33. The method according to claim 27, wherein the image forming apparatus includes the storage medium.

34. The method according to claim 27, wherein the client terminal and the image forming apparatus are operatively connected via a network, said sending and said acquiring being over the network.
